(19) United States
(12) Patent Application Publication
(10) Pub. No.: US 2016/0068731 A1
(43) Pub. Date: Mar. 10, 2016

(54) METHODS AND APPARATUS USING REFRIGERANT COMPOSITIONS COMPRISING REFRIGERANT AND LUBRICANT COMPRISING PERFLUOROPOLYETHER AND NON-FLUORINATED LUBRICANT

(71) Applicant: THE CHEMOURS COMPANY FC, LLC, Wilmington, DE (US)

(72) Inventors: BARBARA HAVILAND MINOR, ELKTON, MD (US); BRIAN RALPH ENGLER, HOCKESSIN, DE (US); THOMAS JOSEPH LECK, HOCKESSIN, DE (US); GREGORY A. BELL, HOCKESSIN, DE (US); JON LEE HOWELL, BEAR, DE (US); KONSTANTINOS KONTOMARIS, WILMINGTON, DE (US)

(21) Appl. No.: 14/782,803

(22) PCT Filed: Apr. 14, 2014
(86) PCT No.: PCT/US2014/033987

§ 371 Date: Oct. 7, 2015

Related U.S. Application Data
(60) Provisional application No. 61/812,303, filed on Apr. 16, 2013.

(51) Int. Cl. C09K 5/04; C10M 107/38

(52) U.S. Cl. CPC C09K 5/045; C10M 107/38; C09K 2205/126; C09K 2205/102; C09K 2205/112

(57) ABSTRACT

Disclosed herein is a method to improve miscibility in refrigeration, air conditioning, heat pump or power cycle systems comprising charging a refrigeration, air conditioning or heat pump system with a refrigerant composition; wherein the refrigerant composition comprises at least one refrigerant and a lubricant comprising at least one perfluoropolyether and at least one non-fluorinated lubricant, provided that the refrigerant composition has no more than two liquid phases over the range of the composition and over a range of temperature from about −40° C. to about +60° C. Also disclosed is a refrigeration, air conditioning, heat pump, or power cycle system containing said refrigerant composition.

### FIELD OF THE INVENTION

The present invention relates to methods to improve miscibility of refrigeration lubricants for use in refrigeration, air conditioning, heat pump and power cycle apparatus.

### BACKGROUND OF THE INVENTION

Lubricants for use with new hydrofluorocarbon and hydrofluoroolefin refrigerants in refrigeration, air conditioning, heat pumps, power cycles and other applications are needed. Mixtures of lubricants may provide properties that conventional lubricants, such as polyol esters (POE's), polyalkylene glycols (PAG's) and mineral oils, for instance, do not provide. Fluorinated lubricants may provide, in particular, the ability to develop lubricant mixtures with reduced flammability. However, perfluoropolyethers have been found to be immiscible with non-fluorinated lubricants conventionally used in refrigeration and air conditioning systems.

U.S. Pat. No. 5,221,494 discloses the use of perfluoropolyethers as lubricants in a refrigeration system using a tetrafluoroethane refrigerant, both as the sole lubricant and mixed with other lubricants. This document focuses on the miscibility of the perfluoropolyether with the refrigerant, but there is no suggestion of the immiscibility of the perfluoropolyether with the other lubricants.

U.S. Patent Application No. 2007-0187639 A1 discloses the use of perfluoropolyether (PFPE) additives in refrigerants and refrigerant/lubricant mixtures to improve energy efficiency and oil-return in vapor compression refrigeration and air conditioning systems, but again fails to recognize the immiscibility of PFPE with non-fluorinated lubricants.

### SUMMARY OF THE INVENTION

It has been found that the addition of a refrigerant to an immiscible mixture of perfluoropolyether (PFPE) lubricant with a non-fluorinated lubricant will improve the miscibility and thus allow the use of an effective amount of PFPE with a refrigerant to provide improved thermal stability and reduce the risk of fire in the event of leakage of, for instance, a flammable refrigerant from a refrigeration, air conditioning, heat pump or power cycle system.

Therefore, in accordance with the present invention, there is provided a method to improve miscibility in refrigeration, air conditioning or heat pump systems comprising:
charging a refrigeration, air conditioning or heat pump system with a refrigerant composition,
wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +200° C.; and
wherein the refrigeration, air conditioning, or heat pump system comprises an evaporator, a condenser, a compressor and an expansion device. In another embodiment the refrigerant compositions has no more than two liquid phase over a range of temperature from about −40° C. to about +160° C.

In addition, in accordance with the present invention, there is provided a refrigeration, air conditioning, or heat pump system comprising an evaporator, a condenser, a compressor and an expansion device; wherein the refrigeration or air conditioning system contains a refrigerant composition comprising at least one flammable refrigerant and a lubricant; wherein the lubricant comprises at least one perfluoropolyether and a non-fluorinated lubricant, provided that the refrigerant composition has no more than two liquid phases over the range of the composition and over a range of temperature from about −40° C. to about +200° C. In another embodiment, the system has no more than two liquid phases over a range of temperature from about −40° C. to about +160° C.

Also in accordance with the present invention, there is provided a method to improve miscibility in power cycle systems comprising: charging a power cycle system with a refrigerant composition; wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +300° C., −40° C. to about +250° C., −40° C. to about +105° C., or −40° C. to about +60° C.; and wherein the power cycle system comprises a working fluid heating unit, an expander, a working fluid cooling unit and a compressor.

Also in accordance with the present invention, there is provided a power cycle system comprising a working fluid heating unit, an expander, a working fluid cooling unit and a compressor; wherein the power cycle system contains a refrigerant composition comprising at least one refrigerant and a lubricant, wherein the lubricant comprises at least one perfluoropolyether and a non-fluorinated lubricant, provided that the refrigerant composition has no more than two liquid phases over the range of the composition and over a range of temperature from about −40° C. to about +300° C., −40° C. to about +250° C., −40° C. to about +105° C., or −40° C. to about +60° C.

### DESCRIPTION OF THE PREFERRED EMBODIMENTS

It is desirable to use a mixture of perfluoropolyether (PFPE) and non-fluorinated lubricant together with a refrigerant. In order for a refrigerant composition including PFPE, non-fluorinated lubricant and refrigerant to function satisfactorily in a refrigeration, air conditioning, heat pump and power cycle system, there must be some measurable level of miscibility amongst the components.

Thus, provided herein is a method to improve miscibility in refrigeration, air conditioning, or heat pump systems comprising:
charging a refrigeration, air conditioning, or heat pump system with a refrigerant composition
wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +200° C., −40° C. to about +160° C., −40° C. to about +105° C., or −40° C. to about +60° C.; and
wherein the refrigeration, air conditioning, or heat pump system comprises an evaporator, a condenser, a compressor and an expansion device.

Also in accordance with the present invention, there is provided a method to improve miscibility in power cycle systems comprising: charging a power cycle system with a refrigerant composition;
wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +300° C., −40° C. to about +250° C., −40° C. to about +105° C., or −40° C. to about +60° C.; and wherein the power cycle system comprises a working fluid heating unit, an expander, a working fluid cooling unit and a compressor.

In some embodiments of the method to improve miscibility in a refrigeration, air conditioning, heat pump and power cycle system, the at least one refrigerant comprises a saturated or unsaturated hydrocarbon. Saturated and unsaturated hydrocarbons include propylene, propane, cyclopropane, isobutene, n-butane, 2-methylbutane and n-pentane, among others. These hydrocarbons are all commercially available from various chemical suppliers.

In some embodiments of the method, the at least one refrigerant comprises a saturated fluorocarbon. Saturated fluorocarbons include, difluoromethane (HFC-32), 1,1,2,2-tetrafluoroethane (HFC-134), 1,1,1,2-tetrafluoroethane (HFC-134a), pentafluoroethane (HFC-125), difluoroethane (HFC-152a), fluoroethane (HFC-161), 1,1,1,2,3,3,3-heptafluoropropane (HFC-227ea), 1,1,1,3,3,3-hexafluoropropane (HFC-236fa), 1,1,1,3,3-pentafluoropropane (HFC-245fa), 1,1,1,2,3-pentafluoropropane (HFC-245eb), and 1,1,1,2,2-pentafluoropropane (HFC-245cb) among others. These fluorocarbons are all commercially available from fluorochemical suppliers, such as E.I. du Pont de Nemours (Wilmington, Del., USA).

In some embodiments of the method, the at least one refrigerant comprises an unsaturated fluorocarbon. Unsaturated fluorocarbons include 2,3,3,3-tetrafluoropropene (HFO-1234yf), 1,3,3,3-tetrafluoropropene (HFO-1234ze, in particular trans-HFO-1234ze), 3,3,3-trifluoropropene (HFO-1243zf), Z-1,1,1,4,4,4-hexafluoro-2-butene (Z-HFO-1336mzz), E-1,1,1,4,4,4-hexafluoro-2-butene (E-HFO-1336mzz); E-1-chloro-3,3,3-trifluoro-propene (E-HCFO-1233zd) among others. These unsaturated fluorocarbons are all commercially available from fluorochemical suppliers, such as E.I. du Pont de Nemours (Wilmington, Del., USA).

In one embodiment of the method, the at least one refrigerant is chosen from HFO-1234yf, trans-HFO-1234ze, HFO-1243zf, HFC-32, HFC-152a, HFC-161 and combinations of two or more thereof. In another embodiment, the at least one refrigerant comprises HFO-1234yf. In another embodiment, the at least one refrigerant comprises trans-HFO-1234ze. In another embodiment, the at least one compound comprises HFC-32. In another embodiment, the at least one compound comprises HFC-152a.

In one embodiment, the refrigerant composition comprises a flammable refrigerant.

Flammability is a term used to mean the ability of a composition to ignite and/or propagate a flame. For refrigerants, a test under conditions specified in ASTM (American Society of Testing and Materials) E-681 is required to determine if a homogeneous mixture of the refrigerant composition and air is capable of propagating a flame.

The flammable refrigerants of the present invention have been classified as flammable under the test conditions described above.

In some embodiments of the method to improve miscibility, the at least one flammable refrigerant comprises a saturated or unsaturated hydrocarbon. Saturated and unsaturated hydrocarbons include propylene, propane, cyclopropane, isobutene, n-butane, 2-methylbutane and n-pentane, among others. These hydrocarbons are all commercially available from various chemical suppliers.

In some embodiments of the method, the at least one flammable refrigerant comprises a saturated fluorocarbon. Saturated fluorocarbons include difluoromethane (HFC-32), difluoroethane (HFC-152a), and fluoroethane (HFC-161), among others. These fluorocarbons are all commercially available from fluorochemical suppliers, such as E.I. du Pont de Nemours (Wilmington, Del., USA).

In some embodiments of the method, at least one flammable refrigerant comprises an unsaturated fluorocarbon. Unsaturated fluorocarbons include 2,3,3,3-tetrafluoropropene (HFO-1234yf), 1,3,3,3-tetrafluoropropene (HFO-1234ze, in particular trans-HFO-1234ze), and 3,3,3-trifluoropropene (HFO-1243zf) among others. These unsaturated fluorocarbons are all commercially available from fluorochemical suppliers, such as E.I. du Pont de Nemours (Wilmington, Del., USA In one embodiment of the method, the at least one flammable refrigerant is chosen from HFO-1234yf, trans-HFO-1234ze, HFO-1243zf, HFC-32, HFC-152a, HFC-161 and combinations of two or more thereof. In another embodiment, the at least one flammable refrigerant comprises HFO-1234yf. In another embodiment, the at least one flammable refrigerant comprises trans-HFO-1234ze. In another embodiment, the at least one flammable compound comprises HFC-32. In another embodiment, the at least one flammable compound comprises HFC-152a.

The refrigerant compositions disclosed herein include at least one perfluoropolyether. Perfluoropolyethers polymers of perfluoroalkyl ether moieties and have at least 2 end groups. In one embodiment, linear perfluoropolyethers have at least two end groups. In another embodiment, perfluoropolyethers have two end groups. In other embodiments, perfluoropolyethers have more than 2 end groups. Perfluoropolyether may be synonymous with perfluoropolyalkylether. Other terms frequently used to mean perfluoropolyether include “PFPE”, “PFAE”, “PFPE oil”, “PFPE fluid”, and “PFPAE”.

In some embodiments, the perfluoropolyether has the formula of CF₃—(CF₂)₂—O—[CF(CF₃)—CF₂—O]j-R′f, or F—(CF(CF₃)CF₂—O)ₙCF₂CF₃ is commercially available from DuPont (Wilmington, Del., USA) under the trademark Krytox®. In the immediately preceding formulas, j is 2-100 and n is 9-60, inclusive and R′f is CF₂CF₃, a C₃ to C₆ perfluoroalkyl group, or combinations thereof.

Other PFPEs, commercially available from Ausimont of Milan, Italy, and Montedison S.p.A., of Milan, Italy, under the trademarks Fomblin® and Galden®, respectively, and produced by perfluoroolefin photooxidation, can also be used. PFPE commercially available under the trademark Fomblin®-Y can have the formula of CF₃O(CF₂CF(CF₃)—O—)ₘ(CF₂—O—)ₙ—R_{1f}. Also suitable is CF₃O[CF₂CF(CF₃)O]m(CF₂CF₂O)ₒ(CF₂O)ₙ—R_{1f}. In the formulae R_{1f} is CF₃, C₂F₅, C₃F₇, or combinations of two or more thereof; m, n, and o may be integers or fractional; (m+n) is 8-45, inclusive; and m/n is 20-1000, inclusive; o is 1; (m+n+o) is 8-45, inclusive; m/n is 20-1000, inclusive.

PFPE commercially available under the trademark Fomblin®-Z can have the formula of CF₃O(CF₂CF₂—O—)ₚ(CF₂—O)_{q}CF₃ where (p+q) is 40-180 and p/q is 0.5-2, inclusive.

Another family of PFPE, commercially available under the trademark Demnum™ from Daikin Industries, Japan, can also be used. It can be produced by sequential oligomerization and fluorination of 2,2,3,3-tetrafluorooxetane, yielding the formula of F—[(CF₂)₃—O]ₜ—R_{2f} where R_{2f} is CF₃, C₂F₅, or combinations thereof and t is 2-200, inclusive.

In some embodiments, the PFPE is unfunctionalized. In an unfunctionalized perfluoropolyether, the end groups can be branched or straight chain perfluoroalkyl radical end groups. Examples of such perfluoropolyethers can have the formula of CᵣF₍₂ᵣ₊₁₎-A-CᵣF₍₂ᵣ₊₁₎ in which each r is independently 3 to 6; A can be O—(CF(CF₃)CF₂—O)_{w}, O—(CF₂—O)ₓ(CF₂CF₂—O)_{y}, O—(C₂F₄—O)_{w}, O—(C₂F₄—O)ₓ(C₃F₆—O)_{y}, O—(CF(CF₃)CF₂—O)ₓ(CF₂—O)_{y}, O—(CF₂CF₂CF₂—O)_{w}, O—(CF(CF₃)CF₂—O)ₓ(CF₂CF₂—O)_{y}—(CF₂—O)_{z}, or combinations of two or more thereof; In some embodiments, A is O—(CF(CF₃)CF₂—O)_{w}, O—(C₂F₄—O)_{w}, O—(C₂F₄—O)ₓ(C₃F₆—O)_{y}, O—(CF₂CF₂CF₂—O)_{w}, or combinations of two or more thereof; w is 4 to 100; x and y are each independently 1 to 100. Specific examples include, but are not limited to, F(CF(CF₃)—(CF₂—O)₉—CF₂CF₃, F(CF(CF₃)—(CF₂—O)₉—CF(CF₃)₂, and combinations thereof. In such PFPEs, up to 30% of the halogen atoms can be halogens other than fluorine, such as, for example, chlorine atoms.

A functionalized PFPE is a PFPE wherein at least one of the end groups of the perfluoropolyether has at least one of its halogen atoms substituted by a group selected from esters, hydroxyls, amines, amides, cyanos, carboxylic acids, sulfonic acids or combinations thereof. In other embodiments, the two end groups of the perfluoropolyether, independently, are functionalized by the same or different groups. In one embodiment, at least one of the end groups of the perfluoropolyether is a carboxylic acid. In one embodiment, at least one of the end groups of the perfluoropolyether is a sulfonic acid.

In some embodiments, representative ester end groups include —COOCH₃, —COOCH₂CH₃, —CF₂COOCH₃, —CF₂COOCH₂CH₃, —CF₂CF₂COOCH₃, —CF₂CF₂COOCH₂CH₃, —CF₂CH₂COOCH₃, —CF₂CF₂CH₂COOCH₃, —CF₂CH₂CH₂COOCH₃, —CF₂CF₂CH₂CH₂COOCH₃.

In some embodiments, representative hydroxyl end groups include —CF₂OH, —CF₂CF₂OH, —CF₂CH₂OH, —CF₂CF₂CH₂OH, —CF₂CH₂CH₂OH, —CF₂CF₂CH₂CH₂OH.

In some embodiments, representative amine end groups include —CF₂NR¹R², —CF₂CF₂NR¹R², —CF₂CH₂NR¹R², —CF₂CF₂CH₂NR¹R², —CF₂CH₂CH₂NR¹R², —CF₂CF₂CH₂CH₂NR¹R², wherein R¹ and R² are independently H, CH₃, or CH₂CH₃.

In some embodiments, representative amide end groups include —CF₂C(O)NR¹R², —CF₂CF₂C(O)NR¹R², —CF₂CH₂C(O)NR¹R², —CF₂C F₂CH₂C(O)NR¹R², —CF₂CH₂CH₂C(O)NR¹R², —CF₂CF₂CH₂CH₂C(O)NR¹R², wherein R¹ and R² are independently H, CH₃, or CH₂CH₃.

In some embodiments, representative cyano end groups include —CF₂CN, —CF₂CF₂CN, —CF₂CH₂CN, —CF₂CF₂CH₂CN, —CF₂CH₂CH₂CN, —CF₂CF₂CH₂CH₂CN.

In some embodiments, representative carboxylic acid end groups include —CF₂COOH, —CF₂CF₂COOH, —CF₂CH₂COOH, —CF₂CF₂CH₂COOH, —CF₂CH₂CH₂COOH, —CF₂CF₂CH₂CH₂COOH.

In some embodiments, the sulfonic acid end groups are selected from the group consisting of —S(O)(O)OR³, —S(O)(O)R⁴, —CF₂OS(O)(O)OR³, —CF₂CF₂OS(O)(O)OR³, —CF₂CH₂OS(O)(O)OR³, —CF₂CF₂CH₂OS(O)(O)OR³, —CF₂CH₂CH₂OS(O)(O)OR³, —CF₂CF₂CH₂CH₂OS(O)(O)OR³, —CF₂S(O)(O) OR³, —CF₂CF₂S(O)(O)OR³, —CF₂CH₂S(O)(O)OR³, —CF₂CF₂CH₂S(O)(O)OR³, —CF₂CH₂CH₂S(O)(O)OR³, —CF₂CF₂CH₂CH₂S(O)(O)OR³, —CF₂OS(O)(O)R⁴, —CF₂CF₂OS(O)(O)R⁴, —CF₂CH₂OS(O)(O)R⁴, —CF₂CF₂CH₂OS(O)(O)R⁴, —CF₂CH₂CH₂OS(O)(O)R⁴, —CF₂CF₂CH₂CH₂OS(O)(O)R⁴, wherein R³ is H, CH₃, CH₂CH₃, CH₂CF₃, CF₃, or CF₂CF₃, and R⁴ is CH₃, CH₂CH₃, CH₂CF₃, CF₃, or CF₂CF₃.

In some embodiments of the method, the perfluoropolyether has viscosity in the range of about 5 to about 1000 centistokes (cSt) at 40° C. In another embodiment, the perfluoropolyether has viscosity in the range of about 20 to about 100 cSt at 40° C. In another embodiment, the perfluoropolyether has viscosity in the range of about 20 to about 80 cSt at 40° C. Viscosity can be determined using a glass capillary viscometer and measured as per ASTM D-445.

Non-fluorinated lubricants may include mineral oils, alkylbenzenes, polyalphaolefins, polyol esters, polyalkylene glycols, polyvinyl ethers, polycarbonates, silicones and combinations of two or more thereof. In one embodiment, the non-fluorinated lubricant is a polyalkylene glycol. In another embodiment, the non-fluorinated lubricant is a polyol ester. In another embodiment, the non-fluorinated lubricant is a polyvinyl ether.

In some embodiments of the method, non-fluorinated lubricants of the present invention comprise mineral oils, which include but are not limited to paraffins (i.e. straight-chain and branched-carbon-chain, saturated hydrocarbons) and naphthenes (i.e. cyclic paraffins). Additionally non-fluorinated lubricants include aromatics (i.e. unsaturated, cyclic hydrocarbons containing one or more rings characterized by alternating double bonds), such as alkylbenzenes. Lubricants of the present invention further comprise those commonly known as alkylaryls (i.e. linear and branched alkyl alkylbenzenes), and poly(alphaolefins).

Representative lubricants of the present invention are lubricants such as, BVM 100 N (paraffinic mineral oil sold by BVA Oils), lubricants sold under the trademark Suniso® 3GS, Suniso® 4GS and Suniso® 5GS (naphthenic mineral oil sold by Sonneborn, Parsippany, N.J., USA), lubricants sold under the trademark Sontex® 372LT (naphthenic mineral oil sold by Pennzoil), lubricants sold under the trademark Calumet® RO-30 (naphthenic mineral oil sold by Calumet Lubricants, Indianapolis, Ind., USA), lubricants sold under the trademarks Zerol® 75, Zerol® 150, Zerol® 200 and Zerol® 500 (linear alkylbenzenes sold by Shrieve Chemicals) and HAB 22 (branched alkylbenzene sold by Nippon Oil). The hydrocarbon-based lubricant is preferably mineral oil.

In other embodiments, non-fluorinated lubricants include, but are not limited to, polyol esters (POEs) such as the POE sold under the trademark Castrol® 100 by Castrol (United Kingdom), under the trademark Ultra 2200® by Copeland Corporation, or under the trademark Emkarate® by Lubrizol, polyalkylene glycols (PAGs) such as RL-488A from Dow Chemical (Midland, Mich.) and PAG PSD1 (available through ACDelco, Grand Blanc, Mich.), polyvinyl ethers (PVEs), silicones, and polycarbonates (PCs) such as MA2320F from Mitsui & Co., Ltd. (Tokyo, Japan).

In the method to improve miscibility the ratio of refrigerant to total lubricant (PFPE plus non-fluorinated lubricant) may be in a range of 99:1 to 1:99. In another embodiment of the method, the ratio of refrigerant to total lubricant may be in a range of 95:5 to 5:95. In another embodiment of the method, the ratio of refrigerant to total lubricant may be in a range of 28:72 to 1:99. In another embodiment of the method, the ratio of refrigerant to lubricant may be in a range of 99.9:0.1 to 75:25.

In the method to improve miscibility the ratio of perfluoropolyether to non-fluorinated lubricant is in a range of about 5:95 to 99:1. In another embodiment, the ratio of perfluoropolyether to non-fluorinated lubricant is in a range of about 10:90 to 99:1. In another embodiment, the ratio of perfluoropolyether to non-fluorinated lubricant is in a range of about 10:90 to 75:25. In another embodiment, the ratio of perfluoropolyether to non-fluorinated lubricant is in a range of about 20:80 to 50:50. In another embodiment, the ratio of perfluoropolyether to non-fluorinated lubricant is in a range of about 5:95 to 20:80.

In certain embodiments, the refrigerant composition has no more than two liquid phases over the range of the composition and over a range of temperature from about −40° C. to about +105° C. In other embodiments, the refrigerant composition has no more than two liquid phases over the range of the composition and over a range of temperature from about −40° C. to about +60° C. In other embodiments, the refrigerant composition has no more than two liquid phases over the range of the composition and over a range of temperature from about −25° C. to about +40° C. In other embodiments, the refrigerant composition has no more than two liquid phases over the range of the composition and over a range of temperature from about −10° C. to about +40° C. In another embodiment, the refrigerant composition has no more than two liquid phases over the range of the composition and over a range of temperature from about +4° C. to about +40° C. In another embodiment, the refrigerant composition has no more than two liquid phases over the range of the composition and over a range of temperature from about +5° C. to about +25° C. In other embodiments, the refrigerant composition has no more than two liquid phases over the range of the composition and over a range of temperature from about −40° C. to about +200° C. In other embodiments, the refrigerant composition has no more than two liquid phases over the range of the composition and over a range of temperature from about −40° C. to about +160° C.

In some embodiments, the miscibility of the refrigerant composition is improved to a greater extent and only one phase or a single phase is present within the system. Therefore in one embodiment of the method, the refrigerant composition has a single liquid phase over the range of the composition and over a range of temperature from about −40° C. to about +105° C. In other embodiments of the method, the refrigerant composition has a single layer over the range of the composition and over a range of temperature from about −40° C. to about +60° C. In another embodiment of the method, the refrigerant composition has a single liquid phase over the range of the composition and over a range of temperature from about −25° C. to about +40° C. In another embodiment of the method, the refrigerant composition has a single liquid phase over the range of the composition and over a range of temperature from about −20° C. to about +40° C. In another embodiment of the method, the refrigerant composition has a single liquid phase over the range of the composition and over a range of temperature from about −10° C. to about +40° C. In another embodiment of the method, the refrigerant composition has a single liquid phase over the range of the composition and over a range of temperature from about +4° C. to about +40° C. In another embodiment of the method, the refrigerant composition has a single liquid phase over the range of the composition and over a range of temperature from about +5° C. to about +25° C. In other embodiments of the method, the refrigerant composition has a single liquid phase over the range of the composition and over a range of temperature from about −40° C. to about +200° C. In other embodiments, the refrigerant composition has a single liquid phase over the range of the composition and over a range of temperature from about −40° C. to about +160° C.

In particular for high temperature heat pumps, the refrigerant composition will require a higher temperature range and therefore the refrigerant composition may have no more than two liquid phases over the temperature range from about −40° C. to about +200° C. or from about −40° C. to about +160° C. Alternatively, for high temperature heat pumps, the refrigerant composition has a single liquid phase over a range of temperature from about −40° C. to about +200° C. or from about −40° C. to about +160° C.

The methods of the present invention may also use refrigerant compositions that further comprise certain refrigeration, air conditioning, heat pump and power cycle system additives, as desired, in order to enhance performance and system stability. These additives are known in the field of refrigeration, air conditioning, heat pump and power cycle, and include, but are not limited to, anti-wear agents, extreme pressure lubricants, corrosion and oxidation inhibitors, metal surface deactivators, free radical scavengers, and foam control agents. In general, these additives may be present in the inventive compositions in small amounts relative to the overall composition. Typically concentrations of from less than about 0.1 weight percent to as much as about 3 weight percent of each additive are used. These additives are selected on the basis of the individual system requirements. These additives include members of the triaryl phosphate family of EP (extreme pressure) lubricity additives, such as butylated triphenyl phosphates (BTPP), or other alkylated triaryl phosphate esters, e.g. Syn-0-Ad 8478 from Akzo Chemicals, tricresyl phosphates and related compounds. Additionally, the metal dialkyl dithiophosphates (e.g., zinc dialkyl dithiophosphate (or ZDDP), Lubrizol 1375 and other members of this family of chemicals may be used in compositions of the present invention. Other antiwear additives include natural product oils and asymmetrical polyhydroxyl lubrication additives, such as Synergol TMS (International Lubricants). Similarly, stabilizers such as antioxidants, free radical scavengers, and water scavengers may be employed. Compounds in this category can include, but are not limited to, butylated hydroxy toluene (BHT), epoxides, and mixtures thereof. Corrosion inhibitors include dodeceyl succinic acid (DDSA), amine phosphate (AP), oleoyl sarcosine, imidazone derivatives and substituted sulfphonates. Metal surface deactivators include areoxalyl bis(benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

### Systems

The refrigerant compositions as described above for use in the method for improving miscibility are also useful in refrigeration, air conditioning, heat pump and power cycle systems.

Thus, in accordance with the present disclosure is provided a refrigeration, air conditioning, or heat pump system comprising an evaporator, a condenser, a compressor and an expansion device; wherein the refrigeration, air conditioning, or heat pump system contains a refrigerant composition comprising at least one refrigerant and a lubricant, wherein the lubricant comprises at least one perfluoropolyether and a non-fluorinated lubricant, provided that the refrigerant composition has no more than two liquid phases over the range of the composition and over a range of temperature from about −40° C. to about +200° C., −40° C. to about +160° C., −40° C. to about +105° C., or −40° C. to about +60° C.

In particular for high temperature heat pump systems, the refrigerant composition will require a higher temperature range and therefore the refrigerant composition may have no more than two liquid phases over the temperature range from about −40° C. to about +200° C. or from about −40° C. to about +160° C. Alternatively, for high temperature heat pump systems, the refrigerant composition has a single liquid phase over a range of temperature from about −40° C. to about +200° C. or from about −40° C. to about +160° C.

Vapor-compression refrigeration, air conditioning, or heat pump systems include an evaporator, a compressor, a condenser, and an expansion device. A refrigeration cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment, at a low temperature to form a gas and produce cooling. Often air or a heat transfer fluid flows over or around the evaporator to transfer the cooling effect caused by the evaporation of the refrigerant in the evaporator to a body to be cooled. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

A refrigeration, air conditioning, or heat pump system is the system (or apparatus) used to produce a heating or cooling effect in a particular space. A refrigeration, air conditioning, or heat pump system may be a mobile system or a stationary system.

Examples of refrigeration, air conditioning, or heat pump systems include, but are not limited to, air conditioners, freezers, refrigerators, heat pumps, high temperature heat pumps, water chillers, flooded evaporator chillers, direct expansion chillers, walk-in coolers, mobile refrigerators, mobile air conditioning units, dehumidifiers, and combinations thereof.

Mobile refrigeration, air conditioning, or heat pump systems are any refrigeration, air conditioner or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “container’ (combined sea/land transport) as well as “swap bodies” (combined road/rail transport).

Stationary refrigeration, air conditioning, or heat pump systems are systems that are fixed in place during operation. A stationary refrigeration, air conditioning, or heat pump system may be associated within or attached to buildings of any variety or may be stand-alone devices located out of doors, such as a soft drink vending machine. These stationary applications may be stationary air conditioning and heat pumps, including but not limited to chillers, high temperature heat pumps, residential, commercial or industrial air conditioning systems (including residential heat pumps), and including window, ductless, ducted, packaged terminal, and those exterior but connected to the building such as rooftop systems. In stationary refrigeration applications, the disclosed compositions may be useful in equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the refrigerant compositions disclosed herein may be used in supermarket refrigeration systems. Additionally, stationary applications may utilize a secondary loop system that uses a primary refrigerant to produce cooling in one location that is transferred to a remote location via a secondary heat transfer fluid.

In one embodiment, the refrigeration, air conditioning, or heat pump system is an automobile air conditioning system. In another embodiment, the refrigeration, air conditioning, or heat pump system is an automobile heat pump system. In another embodiment, the refrigeration, air conditioning, or heat pump system is a stationary air conditioning system. In another embodiment, the refrigeration, air conditioning, or heat pump system is a stationary refrigeration system.

Also in accordance with the present invention, there is provided a power cycle system comprising a working fluid heating unit, an expander, a working fluid cooling unit and a compressor; wherein the power cycle system contains a refrigerant composition comprising at least one refrigerant and a lubricant, wherein the lubricant comprises at least one perfluoropolyether and a non-fluorinated lubricant, provided that the refrigerant composition has no more than two liquid phases over the range of the composition and over a range of temperature from about −40° C. to about +300° C., −40° C. to about +250° C., −40° C. to about +105° C., or −40° C. to about +60° C.

In some embodiments of the refrigeration, air conditioning, heat pump and power cycle system, the at least one refrigerant comprises a saturated or unsaturated hydrocarbon. Saturated and unsaturated hydrocarbons include propylene, propane, cyclopropane, isobutene, n-butane, 2-methylbutane and n-pentane, among others. These hydrocarbons are all commercially available from various chemical suppliers.

In some embodiments of the refrigeration, air conditioning, heat pump and power cycle system, the at least one refrigerant comprises a saturated fluorocarbon. Saturated fluorocarbons include, difluoromethane (HFC-32), 1,1,2,2-tetrafluoroethane (HFC-134), 1,1,1,2-tetrafluoroethane (HFC-134a), pentafluoroethane (HFC-125), difluoroethane (HFC-152a), fluoroethane (HFC-161), 1,1,1,2,3,3,3-heptafluoropropane (HFC-227ea), 1,1,1,3,3,3-hexafluoropropane (HFC-236fa), 1,1,1,3,3-pentafluoropropane (HFC-245fa), 1,1,1,2,3-pentafluoropropane (HFC-245eb), and 1,1,1,2,2-pentafluoropropane (HFC-245cb) among others. These fluorocarbons are all commercially available from fluorochemical suppliers, such as E.I. du Pont de Nemours (Wilmington, Del., USA).

In some embodiments of the refrigeration, air conditioning, heat pump and power cycle system, the at least one refrigerant comprises an unsaturated fluorocarbon. Unsaturated fluorocarbons include 2,3,3,3-tetrafluoropropene (HFO-1234yf), 1,3,3,3-tetrafluoropropene (HFO-1234ze, in particular trans-HFO-1234ze), 3,3,3-trifluoropropene (HFO-1243zf), Z-1,1,1,4,4,4-hexafluoro-2-butene (Z-HFO-1336mzz), E-1,1,1,4,4,4-hexafluoro-2-butene (E-HFO-1336mzz); E-1-chloro-3,3,3-trifluoro-propene (E-HCFO-1233zd) among others. These unsaturated fluorocarbons are all available from fluorochemical suppliers, such as E.I. du Pont de Nemours (Wilmington, Del., USA).

In one embodiment of the refrigeration, air conditioning, heat pump and power cycle system, the at least one refrigerant is chosen from HFO-1234yf, trans-HFO-1234ze, HFO-1243zf, HFC-32, HFC-152a, HFC-161 and combinations of two or more thereof. In another embodiment, the at least one refrigerant comprises HFO-1234yf. In another embodiment, the at least one refrigerant comprises trans-HFO-1234ze. In another embodiment, the at least one refrigerant comprises HFC-32. In another embodiment, the at least one refrigerant comprises HFC-152a.

In one embodiment of the refrigeration, air conditioning, heat pump and power cycle system, the refrigerant composition comprises a flammable refrigerant.

Flammability is a term used to mean the ability of a composition to ignite and/or propagate a flame. For refrigerants, a test under conditions specified in ASTM (American Society of Testing and Materials) E-681 is required to determine if a homogeneous mixture of the refrigerant composition and air is capable of propagating a flame.

The flammable refrigerants of the present invention have been classified as flammable under the test conditions described above.

In some embodiments of the refrigeration, air conditioning, heat pump and power cycle system, the at least one refrigerant is a flammable refrigerant comprising a saturated or unsaturated hydrocarbon. Saturated and unsaturated hydrocarbons include propylene, propane, cyclopropane, isobutene, n-butane, 2-methylbutane and n-pentane, among others. These hydrocarbons are all commercially available from various chemical suppliers.

In some embodiments of the refrigeration, air conditioning, heat pump and power cycle system, the at least one refrigerant is a flammable refrigerant comprising a saturated fluorocarbon. Saturated fluorocarbons include difluoromethane (HFC-32), difluoroethane (HFC-152a), and fluoroethane (HFC-161), among others. These fluorocarbons are all commercially available from fluorochemical suppliers, such as E.I. du Pont de Nemours (Wilmington, Del., USA).

In some embodiments of the refrigeration, air conditioning, heat pump and power cycle system, the at least one flammable refrigerant comprises an unsaturated fluorocarbon. Unsaturated fluorocarbons include 2,3,3,3-tetrafluoropropene (HFO-1234yf), 1,3,3,3-tetrafluoropropene (HFO-1234ze, in particular trans-HFO-1234ze), and 3,3,3-trifluoropropene (HFO-1243zf) among others. These unsaturated fluorocarbons are all available from fluorochemical suppliers, such as E.I. du Pont de Nemours (Wilmington, Del., USA).

In one embodiment of the refrigeration, air conditioning, heat pump and power cycle system, the at least one flammable refrigerant is chosen from HFO-1234yf, trans-HFO-1234ze, HFO-1243zf, HFC-32, HFC-152a, HFC-161 and combinations of two or more thereof. In another embodiment, the at least one flammable refrigerant comprises HFO-1234yf. In another embodiment, the at least one flammable refrigerant comprises trans-HFO-1234ze. In another embodiment, the at least one flammable compound comprises HFC-32. In another embodiment, the at least one flammable compound comprises HFC-152a.

The refrigerant compositions disclosed herein for use in the refrigeration, air conditioning, heat pump and power cycle systems include at least one perfluoropolyether. Perfluoropolyethers polymers of perfluoroalkyl ether moieties and have at least 2 end groups. In one embodiment, linear perfluoropolyethers have at least two end groups. In another embodiment, perfluoropolyethers have two end groups. In other embodiments, perfluoropolyethers have more than 2 end groups. Perfluoropolyether may be synonymous with perfluoropolyalkylether. Other terms frequently used to mean perfluoropolyether include “PFPE”, “PFAE”, “PFPE oil”, “PFPE fluid”, and “PFPAE”.

In some embodiments, the perfluoropolyether has the formula of CF₃—(CF₂)₂—O—[CF(CF₃)—CF₂—O]j-R′f, or F—(CF(CF₃)CF₂—O)ₙCF₂CF₃ and is commercially available from DuPont (Wilmington, Del., USA) under the trademark Krytox®. In the immediately preceding formula, j is 2-100 and n is 9-60, inclusive and R′f is CF₂CF₃, a C₃ to C₆ perfluoroalkyl group, or combinations thereof.

Other PFPEs, commercially available from Ausimont of Milan, Italy, and Montedison S.p.A., of Milan, Italy, under the trademarks Fomblin® and Galden®, respectively, and produced by perfluoroolefin photooxidation, can also be used. PFPE commercially available under the trademark Fomblin®-Y can have the formula of CF₃O(CF₂CF(CF₃)—O—)ₘ(CF₂—O—)ₙ—R_{1f}. Also suitable is CF₃O[CF₂CF(CF₃)O]ₘ(CF₂CF₂O)ₒ(CF₂O)ₙ—R_{1f}. In the formulae R_{1f} is CF₃, C₂F₅, C₃F₇, or combinations of two or more thereof; m, n, and o may be integers or fractional; (m+n) is 8-45, inclusive; and m/n is 20-1000, inclusive; o is 1; (m+n+o) is 8-45, inclusive; m/n is 20-1000, inclusive.

PFPE commercially available under the trademark Fomblin®-Z can have the formula of CF₃O(CF₂CF₂—O—)ₚ(CF₂—O)_{q}CF₃ where (p+q) is 40-180 and p/q is 0.5-2, inclusive.

Another family of PFPE, commercially available under the trademark Demnum™ from Daikin Industries, Japan, can also be used. It can be produced by sequential oligomerization and fluorination of 2,2,3,3-tetrafluorooxetane, yielding the formula of F—[(CF₂)₃—O]ₜ—R_{2f} where R_{2f} is CF₃, C₂F₅, or combinations thereof and t is 2-200, inclusive.

In some embodiments, the PFPE is unfunctionalized. In an unfunctionalized perfluoropolyether, the end groups can be branched or straight chain perfluoroalkyl radical end groups. Examples of such perfluoropolyethers can have the formula of CᵣF₍₂ᵣ₊₁₎-A-CᵣF₍₂ᵣ₊₁₎ in which each r is independently 3 to 6; A can be O—(CF(CF₃)CF₂—O)_{w}, O—(CF₂—O)ₓ(CF₂CF₂—O)_{y}, O—(C₂F₄—O)_{w}, O—(C₂F₄—O)ₓ(C₃F₆—O)_{y}, O—(CF(CF₃)CF₂—O)ₓ(CF₂—O)_{y}, O—(CF₂CF₂CF₂—O)_{w}, O—(CF(CF₃)CF₂—O)ₓ(CF₂CF₂—O)_{y}—(CF₂—O)_{z}, or combinations of two or more thereof; In some embodiments, A is O—(CF(CF₃)CF₂—O)_{w}, O—(C₂F₄—O)_{w}, O—(C₂F₄—O)ₓ(C₃F₆—O)_{y}, O—(CF₂CF₂CF₂—O)_{w}, or combinations of two or more thereof; w is 4 to 100; x and y are each independently 1 to 100. Specific examples include, but are not limited to, F(CF(CF₃)—CF₂—O)₉—CF₂CF₃, F(CF(CF₃)—CF₂—O)₉—CF(CF₃)₂, and combinations thereof. In such PFPEs, up to 30% of the halogen atoms can be halogens other than fluorine, such as, for example, chlorine atoms.

A functionalized PFPE is a PFPE wherein at least one of the end groups of the perfluoropolyether has at least one of its halogen atoms substituted by a group selected from esters, hydroxyls, amines, amides, cyanos, carboxylic acids, sulfonic acids or combinations thereof. In other embodiments, the two end groups of the perfluoropolyether, independently, are functionalized by the same or different groups. In one embodiment, at least one of the end groups of the perfluoropolyether is a carboxylic acid. In one embodiment, at least one of the end groups of the perfluoropolyether is a sulfonic acid.

In some embodiments, representative ester end groups include —COOCH₃, —COOCH₂CH₃, —CF₂COOCH₃, —CF₂COOCH₂CH₃, —CF₂CF₂COOCH₃, —CF₂CF₂COOCH₂CH₃, —CF₂CH₂COOCH₃, —CF₂CF₂CH₂COOCH₃, —CF₂CH₂CH₂COOCH₃, —CF₂CF₂CH₂CH₂COOCH₃.

In some embodiments, representative hydroxyl end groups include —CF₂OH, —CF₂CF₂OH, —CF₂CH₂OH, —CF₂CF₂CH₂OH, —CF₂CH₂CH₂OH, —CF₂CF₂CH₂CH₂OH.

In some embodiments, representative amine end groups include —CF₂NR¹R², —CF₂CF₂NR¹R², —CF₂CH₂NR¹R², —CF₂CF₂CH₂NR¹R², —CF₂CH₂CH₂NR¹R², —CF₂CF₂CH₂CH₂NR¹R², wherein R¹ and R² are independently H, CH₃, or CH₂CH₃.

In some embodiments, representative amide end groups include —CF₂C(O)NR¹R², —CF₂CF₂C(O)NR¹R², —CF₂CH₂C(O)NR¹R², —CF₂CF₂CH₂C(O)NR¹R², —CF₂CH₂CH₂C(O)NR¹R², —CF₂CF₂CH₂CH₂C(O)NR¹R², wherein R¹ and R² are independently H, CH₃, or CH₂CH₃.

In some embodiments, representative cyano end groups include —CF₂CN, —CF₂CF₂CN, —CF₂CH₂CN, —CF₂CF₂CH₂CN, —CF₂CH₂CH₂CN, —CF₂CF₂CH₂CH₂CN.

In some embodiments, representative carboxylic acid end groups include —CF₂COOH, —CF₂CF₂COOH, —CF₂CH₂COOH, —CF₂CF₂CH₂COOH, —CF₂CH₂CH₂COOH, —CF₂CF₂CH₂CH₂COOH.

In some embodiments, the sulfonic acid end groups are selected from the group consisting of —S(O)(O)OR³, —S(O)(O)R⁴, —CF₂OS(O)(O)OR³, —CF₂CF₂OS(O)(O)OR³, —CF₂CH₂OS(O)(O)OR³, —CF₂CF₂CH₂OS(O)(O)OR³, —CF₂CH₂CH₂OS(O)(O)OR³, —CF₂CF₂CH₂CH₂OS(O)(O)OR³, —CF₂S(O)(O)OR³, —CF₂CF₂S(O)(O)OR³, —CF₂CH₂S(O)(O)OR³, —CF₂CF₂CH₂S(O)(O)OR³, —CF₂CH₂CH₂S(O)(O)OR³, —CF₂CF₂CH₂CH₂S(O)(O)OR³, —CF₂OS(O)(O)R⁴, —CF₂CF₂OS(O)(O)R⁴, —CF₂CH₂OS(O)(O)R⁴, —CF₂CF₂CH₂OS(O)(O)R⁴, —CF₂CH₂CH₂OS(O)(O)R⁴, —CF₂CF₂CH₂CH₂OS(O)(O)R⁴, wherein R³ is H, CH₃, CH₂CH₃, CH₂CF₃, CF₃, or CF₂CF₃, and R⁴ is CH₃, CH₂CH₃, CH₂CF₃, CF₃, or CF₂CF₃.

In some embodiments of the refrigeration, air conditioning, heat pump or power cycle system, the perfluoropolyether has viscosity in the range of about 5 to about 1000 centistokes (cSt) at 40° C. In another embodiment, the perfluoropolyether has viscosity in the range of about 20 to about 100 cSt at 40° C. In another embodiment, the perfluoropolyether has viscosity in the range of about 20 to about 80 cSt at 40° C.

Non-fluorinated lubricants for use in the refrigeration and air conditioning systems may include mineral oils, alkylbenzenes, polyalphaolefins, polyol esters, polyalkylene glycols, polyvinyl ethers, polycarbonates, silicones and combinations of two or more thereof. In one embodiment, the non-fluorinated lubricant is a polyalkylene glycol. In another embodiment, the non-fluorinated lubricant is a polyol ester. In another embodiment, the non-fluorinated lubricant is a polyvinyl ether.

In some embodiments of the refrigeration, air conditioning, heat pump or power cycle system, non-fluorinated lubricants of the present invention comprise mineral oils, which include but are not limited to paraffins (i.e. straight-chain and branched-carbon-chain, saturated hydrocarbons) and naphthenes (i.e. cyclic paraffins). Additionally non-fluorinated lubricants include aromatics (i.e. unsaturated, cyclic hydrocarbons containing one or more rings characterized by alternating double bonds), such as alkylbenzenes. Lubricants of the present invention further comprise those commonly known as alkylaryls (i.e. linear and branched alkyl alkylbenzenes), and poly(alphaolefins).

Representative lubricants of the present invention are lubricants such as, BVM 100 N (paraffinic mineral oil sold by BVA Oils), lubricants sold under the trademark Suniso® 3GS, Suniso® 4GS and Suniso® 5GS (naphthenic mineral oil sold by Crompton Co.), lubricants sold under the trademark Sontex®372LT (naphthenic mineral oil sold by Pennzoil), lubricants sold under the trademark Calumet® RO-30 (naphthenic mineral oil sold by Calumet Lubricants), lubricants sold under the trademarks Zerol® 75, Zerol® 150, Zerol® 200 and Zerol® 500 (linear alkylbenzenes sold by Shrieve Chemicals) and HAB 22 (branched alkylbenzene sold by Nippon Oil). The hydrocarbon-based lubricant is preferably mineral oil.

In other embodiments of the refrigeration, air conditioning, heat pump or power cycle system, non-fluorinated lubricants include, but are not limited to, polyol esters (POEs) such as the POE sold under the trademark Castrol® 100 by Castrol (United Kingdom), under the trademark Ultra 22CC° by Copeland Corporation, or under the trademark Emkarate® by Uniqema, polyalkylene glycols (PAGs) such as RL-488A from Dow Chemical (Midland, Mich.) and PAG PSD1 (available through ACDelco, Grand Blanc, Mich.), polyvinyl ethers (PVEs), silicones, and polycarbonates (PCs) such as MA2320F from Mitsui & Co., Ltd. (Tokyo, Japan).

In the refrigeration, air conditioning, heat pump or power cycle system the ratio of refrigerant to total lubricant (PFPE plus non-fluorinated lubricant) may be in a range of 99:1 to 1:99. In another embodiment of the system, the ratio of refrigerant to total lubricant may be in a range of 95:5 to 5:95. In another embodiment of the system, the ratio of refrigerant to total lubricant may be in a range of 28:72 to 1:99. In another embodiment of the system, the ratio of refrigerant to lubricant may be in a range of 99.9:0.1 to 75:25.

In the refrigeration, air conditioning, heat pump or power cycle system the ratio of perfluoropolyether to non-fluorinated lubricant is in a range of about 5:95 to 99:1. In another embodiment, the ratio of perfluoropolyether to non-fluorinated lubricant is in a range of about 10:90 to 99:1. In another embodiment, the ratio of perfluoropolyether to non-fluorinated lubricant is in a range of about 10:90 to 75:25. In another embodiment, the ratio of perfluoropolyether to non-fluorinated lubricant is in a range of about 20:80 to 50:50. In another embodiment, the ratio of perfluoropolyether to non-fluorinated lubricant is in a range of about 5:95 to 20:80.

In certain embodiments of the refrigeration, air conditioning, or heat pump system, the refrigerant composition has no more than two liquid phases over the range of the composition and over a range of temperature from about −40° C. to about +105° C. In other embodiments, the refrigerant composition has no more than two liquid phases over the range of the composition and over a range of temperature from about −40° C. to about +60° C. In other embodiments, the refrigerant composition has no more than two liquid phases over the range of the composition and over a range of temperature from about −25° C. to about +40° C. In other embodiments, the refrigerant composition has no more than two liquid phases over the range of the composition and over a range of temperature from about −10° C. to about +40° C. In another embodiment, the refrigerant composition has no more than two liquid phases over the range of the composition and over a range of temperature from about +4° C. to about +40° C. In another embodiment, the refrigerant composition has no more than two liquid phases over the range of the composition and over a range of temperature from about +5° C. to about +25° C. In other embodiments of the system, the refrigerant composition has not more than two liquid phases over the range of compositions and over a range of temperature from about −40° C. to about +200° C. In other embodiments of the system, the refrigerant composition has not more than two liquid phases over the range of compositions and over a range of temperature from about −40° C. to about +160° C.

In some embodiments of the system, the miscibility of the refrigerant composition is improved to a greater extent and only one phase or a single phase is present within the system. Therefore in one embodiment of the system, the refrigerant composition has a single liquid phase over the range of the composition and over a range of temperature from about −40° C. to about +105° C. In another embodiment of the system, the refrigerant composition has a single liquid phase over the range of the composition and over a range of temperature from about −40° C. to about +60° C. In another embodiment of the system, the refrigerant composition has a single liquid phase over the range of the composition and over a range of temperature from about −25° C. to about +40° C. In another embodiment of the system, the refrigerant composition has a single liquid phase over the range of the composition and over a range of temperature from about −20° C. to about +40° C. In another embodiment of the system, the refrigerant composition has a single liquid phase over the range of the composition and over a range of temperature from about −10° C. to about +40° C. In another embodiment of the system, the refrigerant composition has a single liquid phase over the range of the composition and over a range of temperature from about +4° C. to about +40° C. In another embodiment of the system, the refrigerant composition has a single liquid phase over the range of the composition and over a range of temperature from about +5° C. to about +25° C. In other embodiments of the system, the refrigerant composition has a single liquid phase over the range of compositions and over a range of temperature from about −40° C. to about +200° C. In other embodiments of the system, the refrigerant composition has a single liquid phase over the range of compositions and over a range of temperature from about −40° C. to about +160° C.

The methods of the present invention may also use refrigerant compositions that further comprise certain refrigeration, air conditioning, or heat pump system additives, as desired, in order to enhance performance and system stability. These additives are known in the field of refrigeration and air-conditioning, and include, but are not limited to, anti-wear agents, extreme pressure lubricants, corrosion and oxidation inhibitors, metal surface deactivators, free radical scavengers, and foam control agents. In general, these additives may be present in the inventive compositions in small amounts relative to the overall composition. Typically concentrations of from less than about 0.1 weight percent to as much as about 3 weight percent of each additive are used. These additives are selected on the basis of the individual system requirements. These additives include members of the triaryl phosphate family of EP (extreme pressure) lubricity additives, such as butylated triphenyl phosphates (BTPP), or other alkylated triaryl phosphate esters, e.g. Syn-0-Ad 8478 from Akzo Chemicals, tricresyl phosphates and related compounds. Additionally, the metal dialkyl dithiophosphates (e.g., zinc dialkyl dithiophosphate (or ZDDP), Lubrizol 1375 and other members of this family of chemicals may be used in compositions of the present invention. Other antiwear additives include natural product oils and asymmetrical polyhydroxyl lubrication additives, such as Synergol TMS (International Lubricants). Similarly, stabilizers such as antioxidants, free radical scavengers, and water scavengers may be employed. Compounds in this category can include, but are not limited to, butylated hydroxy toluene (BHT), epoxides, and mixtures thereof. Corrosion inhibitors include dodeceyl succinic acid (DDSA), amine phosphate (AP), oleoyl sarcosine, imidazone derivatives and substituted sulfphonates. Metal surface deactivators include areoxalyl bis(benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

### EXAMPLES

The concepts disclosed herein will be further described in the following examples, which do not limit the scope of the invention described in the claims.

The following materials were used in carrying out the examples; PAG PSD1 is a polyalkylene glycol lubricant obtained from AC Delco (Grand Blanc, Mich.); POE RL 22 H, POE RL 32 H, and POE RL 68 H are polyol ester lubricants sold under the trademark Emkarate® obtained from Nu-Calgon (St. Louis, Mo.); Krytox® GPL 104, GPL 105, and GPL 106 are a non-functionalized perfluoropolyethers from E.I. du Pont de Nemour (Wilmington, Del.); Krytox®157 FS(L) is a functionalized perfluoropolyether from E.I. du Pont de Nemour (Wilmington, Del.); HFC-1234yf (2,3,3,3-tetrafluoropropene) refrigerant from E.I. du Pont de Nemours (Wilmington, Del.).

### Example 1

### Miscibility

Lubricant mixtures were tested for miscibility in the presence of a refrigerant by the following method. Refrigerant and lubricant mixture compositions were loaded into sealed glass tubes at varying refrigerant and lubricant concentrations by volume. In most cases, HFO-1234yf refrigerant, one PFPE lubricant and one non-fluorinated lubricant were loaded in the tubes. The tubes were then subjected to different temperatures and observed visually for the number of phases present. If one phase was observed, the refrigerant and two lubricants achieved complete miscibility. If three phases were observed, there was no miscibility achieved between any of the phases. It is desirable to have one or two phases showing improvement in miscibility. Results are shown in Tables 1 through 12. Table 1 shows miscibility data for pure PAG with HFO-1234yf refrigerant. Tables 2-4 shows miscibility data for Krytox®GPL 104/PAG/1234yf; Tables 5-8 shows miscibility data for Krytox®FS(L)/PAG/1234yf; Tables 9-11 shows miscibility data for Krytox®GPL 104/POE/1234yf; and Tables 12-14 shows miscibility data for Krytox®FS(L)/POE/1234yf.

TABLE 1
Miscibility data for pure PAG with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 2 | 2 | 2 | 2 | 2 | 2 | 2 | 2 | 2 | 2 | 2 | 2 | 2 | 2 | 2 | 2 | 2 | 2 | 2 | 2 | 2 |
| 75/25 | 2 | 2 | 2 | 2 | 2 | 2 | 2 | 2 | 2 | 2 | 2 | 2 | 2 | 2 | 2 | 2 | 2 | 2 | 2 | 2 | 2 |
| 50/50 | 2 | 2 | 2 | 2 | 2 | 2 | 2 | 2 | 2 | 2 | 2 | 2 | 2 | 2 | 2 | 2 | 2 | 2 | 2 | 2 | 2 |
| 25/75 | 1 | 1 | 1 | 1 | 1 | 1 | 1 | 1 | 1 | 1 | 1 | 1 | 1 | 2 | 2 | 2 | 2 | 2 | 2 | 2 | 2 |
| 10/90 | 1 | 1 | 1 | 1 | 1 | 1 | 1 | 1 | 1 | 1 | 1 | 1 | 1 | 1 | 1 | 1 | 1 | 1 | 1 | 1 | 1 |
| 5/95 | 1 | 1 | 1 | 1 | 1 | 1 | 1 | 1 | 1 | 1 | 1 | 1 | 1 | 1 | 1 | 1 | 1 | 1 | 1 | 1 | 1 |

TABLE 2
Miscibility data for 25% Krytox ®GPL 104/
75% PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 2 | 2 | 2 | 2 | 2 | 2 | 2 |
| 90/10 | 2 | 2 | 2 | 2 | 2 | 2 | 2 | 2 | 2 | 2 | 2 | 2 | 2 | 2 | 2 | 2 | 2 | 2 | 2 | 2 | 2 |
| 75/25 | 2 | 2 | 2 | 2 | 2 | 2 | 2 | 2 | 2 | 2 | 2 | 2 | 2 | 2 | 2 | 2 | 2 | 2 | 2 | 2 | 2 |
| 50/50 | 2 | 2 | 2 | 2 | 2 | 2 | 2 | 2 | 2 | 2 | 2 | 2 | 2 | 2 | 2 | 2 | 2 | 2 | 2 | 2 | 2 |
| 40/60 | 2 | 2 | 2 | 2 | 2 | 2 | 2 | 2 | 2 | 2 | 2 | 2 | 2 | 2 | 2 | 2 | 2 | 2 | 2 | 2 | 2 |
| 30/70 | 2 | 2 | 2 | 2 | 2 | 2 | 2 | 2 | 2 | 2 | 2 | 2 | 2 | 2 | 2 | 2 | 2 | 2 | 2 | 2 | 2 |
| 20/80 | 2 | 2 | 2 | 2 | 2 | 2 | 2 | 2 | 2 | 2 | 2 | 2 | 2 | 2 | 2 | 2 | 2 | 2 | 2 | 2 | 2 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 3
Miscibility data for 50% Krytox ®GPL 104/
50% PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 2 | 2 | 2 | 2 | 2 | 2 | 2 |
| 90/10 | 1 | 1 | 1 | 1 | 1 | 1 | 1 | 1 | 1 | 1 | 1 | 1 | 1 | 1 | 2 | 2 | 2 | 2 | 2 | 2 | 2 |
| 75/25 | 2 | 2 | 2 | 2 | 2 | 2 | 2 | 2 | 2 | 2 | 2 | 2 | 2 | 2 | 2 | 2 | 2 | 2 | 2 | 2 | 2 |
| 50/50 | 2 | 2 | 2 | 2 | 2 | 2 | 2 | 2 | 2 | 2 | 2 | 2 | 2 | 2 | 2 | 2 | 2 | 2 | 2 | 2 | 2 |
| 25/75 | 2 | 2 | 2 | 2 | 2 | 2 | 2 | 2 | 2 | 2 | 2 | 2 | 2 | 2 | 2 | 2 | 2 | 2 | 2 | 2 | 2 |
| 10/90 | 2 | 2 | 2 | 2 | 2 | 2 | 2 | 2 | 2 | 2 | 2 | 2 | 2 | 2 | 2 | 2 | 2 | 2 | 2 | 2 | 2 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 4
Miscibility data for 75% Krytox ®GPL 104/
25% PAG PDS1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 2 | 2 | 2 | 2 | 2 | 2 | 2 |
| 90/10 | 1 | 1 | 1 | 1 | 1 | 1 | 1 | 1 | 1 | 1 | 1 | 1 | 1 | 1 | 2 | 2 | 2 | 2 | 2 | 2 | 2 |
| 75/25 | 1 | 1 | 1 | 1 | 1 | 1 | 1 | 1 | 1 | 1 | 1 | 1 | 1 | 1 | 2 | 2 | 2 | 2 | 2 | 2 | 2 |
| 50/50 | 2 | 2 | 2 | 2 | 2 | 2 | 2 | 2 | 2 | 2 | 2 | 2 | 2 | 2 | 2 | 2 | 2 | 2 | 2 | 2 | 2 |
| 25/75 | 2 | 2 | 2 | 2 | 2 | 2 | 2 | 2 | 2 | 2 | 2 | 2 | 2 | 2 | 2 | 2 | 2 | 2 | 2 | 2 | 2 |
| 10/90 | 2 | 2 | 2 | 2 | 2 | 2 | 2 | 2 | 2 | 2 | 2 | 2 | 2 | 2 | 2 | 2 | 2 | 2 | 2 | 2 | 2 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 5
Miscibility data for 25% Krytox ® FS(L)/
75% PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 2 | 2 | 2 | 2 | 2 | 2 |
| 90/10 | 1 | 1 | 1 | 1 | 1 | 1 | 1 | 1 | 1 | 1 | 1 | 1 | 1 | 2 | 2 | 2 | 2 | 2 | 2 | 2 | 2 |
| 75/25 | 1 | 1 | 1 | 1 | 1 | 1 | 1 | 1 | 1 | 1 | 1 | 1 | 1 | 2 | 2 | 2 | 2 | 2 | 2 | 2 | 2 |
| 50/50 | 1 | 1 | 1 | 1 | 1 | 1 | 1 | 1 | 1 | 1 | 1 | 1 | 1 | 2 | 2 | 2 | 2 | 2 | 2 | 2 | 2 |
| 25/75 | 3 | 3 | 2 | 2 | 2 | 2 | 2 | 2 | 2 | 2 | 2 | 2 | 2 | 2 | 2 | 2 | 2 | 2 | 2 | 2 | 2 |
| 10/90 | 3 | 3 | 2 | 2 | 2 | 2 | 2 | 2 | 2 | 2 | 2 | 2 | 2 | 2 | 2 | 2 | 2 | 2 | 2 | 2 | 2 |
| 5/95 | 3 | 3 | 3 | 3 | 3 | 2 | 2 | 2 | 2 | 2 | 2 | 2 | 2 | 2 | 2 | 2 | 2 | 2 | 2 | 2 | 2 |

TABLE 6
Miscibility data for 50% Krytox ® FS(L)/50%
PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 2 | 2 |
| 90/10 | 1 | 1 | 1 | 1 | 1 | 1 | 1 | 1 | 1 | 1 | 1 | 1 | 1 | 1 | 1 | 1 | 2 | 2 | 2 | 2 | 2 |
| 75/25 | 1 | 1 | 1 | 1 | 1 | 1 | 1 | 1 | 1 | 1 | 1 | 1 | 1 | 2 | 2 | 2 | 2 | 2 | 2 | 2 | 2 |
| 50/50 | 1 | 1 | 1 | 1 | 1 | 1 | 1 | 1 | 1 | 1 | 1 | 1 | 1 | 2 | 2 | 2 | 2 | 2 | 2 | 2 | 2 |
| 25/75 | 3 | 3 | 3 | 3 | 3 | 3 | 3 | 3 | 3 | 3 | 3 | 2 | 2 | 2 | 2 | 2 | 2 | 2 | 2 | 2 | 2 |
| 10/90 | 3 | 3 | 3 | 3 | 3 | 3 | 3 | 3 | 3 | 3 | 3 | 2 | 2 | 2 | 2 | 2 | 2 | 2 | 2 | 2 | 2 |
| 5/95 | 3 | 3 | 3 | 3 | 3 | 3 | 3 | 3 | 3 | 3 | 3 | 2 | 2 | 2 | 2 | 2 | 2 | 2 | 2 | 2 | 2 |

TABLE 7
Miscibility data for 75% Krytox ® FS(L)/
25% PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 1 | 1 | 1 | 1 | 1 | 1 | 1 | 1 | 1 | 1 | 1 | 1 | 1 | 1 | 1 | 2 | 2 | 2 | 2 | 2 | 2 |
| 50/50 | 2 | 2 | 1 | 1 | 1 | 1 | 1 | 1 | 1 | 1 | 1 | 1 | 1 | 2 | 2 | 2 | 2 | 2 | 2 | 2 | 2 |
| 25/75 | 2 | 2 | 2 | 2 | 2 | 2 | 2 | 2 | 2 | 2 | 2 | 2 | 2 | 2 | 2 | 2 | 2 | 2 | 2 | 2 | 2 |
| 10/90 | 3 | 3 | 3 | 3 | 3 | 3 | 3 | 3 | 3 | 3 | 3 | 3 | 3 | 2 | 2 | 2 | 2 | 2 | 2 | 2 | 2 |
| 5/95 | 3 | 3 | 3 | 3 | 3 | 3 | 3 | 3 | 3 | 3 | 3 | 3 | 3 | 2 | 2 | 2 | 2 | 2 | 2 | 2 | 2 |

TABLE 8
Miscibility data for 90% Krytox ® FS(L)/
10% PAG PSD1 with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 1 | 1 | 1 | 1 | 1 | 1 | 1 | 1 | 1 | 1 | 1 | 1 | 1 | 1 | 1 | 1 | 1 | 1 | 1 | 1 | 1 |
| 50/50 | 1 | 1 | 1 | 1 | 1 | 1 | 1 | 1 | 1 | 1 | 1 | 1 | 1 | 1 | 1 | 1 | 1 | 1 | 1 | 1 | 1 |
| 25/75 | 1 | 1 | 1 | 1 | 1 | 1 | 1 | 1 | 1 | 1 | 1 | 1 | 1 | 1 | 1 | 1 | 1 | 1 | 1 | 1 | 1 |
| 10/90 | 1 | 1 | 1 | 1 | 1 | 1 | 1 | 1 | 1 | 1 | 1 | 1 | 1 | 1 | 1 | 1 | 1 | 1 | 1 | 1 | 1 |
| 5/95 | 1 | 1 | 1 | 1 | 1 | 1 | 1 | 1 | 1 | 1 | 1 | 1 | 1 | 1 | 1 | 1 | 1 | 1 | 1 | 1 | 1 |

TABLE 9
Miscibility data for 25% Krytox ®GPL104/75% POE RL32H with HFO-1234yf refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 2 | 2 | 2 | 2 | 2 | 2 | 1 | 1 | 1 | 1 | 1 | 1 | 1 | 1 | 1 | 1 | 1 | 1 | 2 | 2 | 2 |
| 50/50 | 2 | 2 | 2 | 2 | 2 | 2 | 2 | 2 | 2 | 2 | 2 | 2 | 2 | 2 | 2 | 2 | 2 | 2 | 2 | 2 | 2 |
| 40/60 | 2 | 2 | 2 | 2 | 2 | 2 | 2 | 2 | 2 | 2 | 2 | 2 | 2 | 2 | 2 | 2 | 2 | 2 | 2 | 2 | 2 |
| 30/70 | 2 | 2 | 2 | 2 | 2 | 2 | 2 | 2 | 2 | 2 | 2 | 2 | 2 | 2 | 2 | 2 | 2 | 2 | 2 | 2 | 2 |
| 20/80 | 2 | 2 | 2 | 2 | 2 | 2 | 2 | 2 | 2 | 2 | 2 | 2 | 2 | 2 | 2 | 2 | 2 | 2 | 2 | 2 | 2 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 10
Miscibility data for 50% Krytox ®GPL 104/50% POE RL32H with HFO-1234yv refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 3 | 3 | 3 | 3 | 3 | 2 | 2 | 2 | 2 | 1 | 1 | 1 | 1 | 1 | 1 | 1 | 1 | 1 | 2 | 2 | 2 |
| 50/50 | 3 | 3 | 3 | 3 | 3 | 3 | 2 | 2 | 2 | 2 | 2 | 2 | 2 | 2 | 2 | 2 | 2 | 2 | 2 | 3 | 3 |
| 40/60 | 2 | 2 | 2 | 2 | 2 | 2 | 2 | 2 | 2 | 2 | 2 | 2 | 2 | 2 | 2 | 2 | 2 | 2 | 2 | 2 | 3 |
| 30/70 | 2 | 2 | 2 | 2 | 2 | 2 | 2 | 2 | 2 | 2 | 2 | 2 | 2 | 2 | 2 | 2 | 2 | 2 | 2 | 2 | 3 |
| 20/80 | 2 | 2 | 2 | 2 | 2 | 2 | 2 | 2 | 2 | 2 | 2 | 2 | 2 | 2 | 2 | 2 | 2 | 2 | 2 | 2 | 2 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 11
Miscibility data for 75% GPL 104/25% POE RL 32 H with HFO-1234yv refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 2 | 2 | 2 | 2 | 2 | 2 | 2 | 2 | 1 | 1 | 1 | 1 | 1 | 1 | 1 | 1 | 1 | 1 | 1 | 1 | 1 |
| 50/50 | 2 | 2 | 2 | 2 | 2 | 2 | 2 | 2 | 2 | 2 | 2 | 2 | 2 | 2 | 2 | 2 | 2 | 2 | 3 | 3 | 3 |
| 40/60 | 2 | 2 | 2 | 2 | 2 | 2 | 2 | 2 | 2 | 2 | 2 | 2 | 2 | 2 | 2 | 2 | 2 | 2 | 2 | 2 | 3 |
| 30/70 | 2 | 2 | 2 | 2 | 2 | 2 | 2 | 2 | 2 | 2 | 2 | 2 | 2 | 2 | 2 | 2 | 2 | 2 | 2 | 2 | 3 |
| 20/80 | 2 | 2 | 2 | 2 | 2 | 2 | 2 | 2 | 2 | 2 | 2 | 2 | 2 | 2 | 2 | 2 | 2 | 2 | 2 | 2 | 3 |
| 5/95 | 2 | 2 | 2 | 2 | 2 | 2 | 2 | 2 | 2 | 2 | 2 | 2 | 2 | 2 | 2 | 2 | 2 | 2 | 2 | 2 | 2 |

TABLE 12
Miscibility data for 25% Krytox ® FSL/75% POE RL 32 H with HFO-1234yv refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature (° C.) | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 1 | 1 | 1 | 1 | 1 | 1 | 1 | 1 | 1 | 1 | 1 | 1 | 1 | 1 | 1 | 1 | 1 | 1 | 1 | 1 | 1 |
| 50/50 | 3 | 3 | 3 | 3 | 3 | 3 | 3 | 3 | 3 | 1 | 1 | 1 | 1 | 1 | 1 | 1 | 1 | 1 | 1 | 1 | 1 |
| 40/60 | 4 | 4 | 4 | 3 | 3 | 3 | 3 | 3 | 3 | 2 | 1 | 1 | 1 | 1 | 1 | 1 | 1 | 1 | 1 | 1 | 1 |
| 30/70 | 4 | 4 | 4 | 4 | 4 | 4 | 4 | 3 | 3 | 3 | 3 | 3 | 3 | 2 | 2 | 2 | 2 | 2 | 2 | 2 | 2 |
| 20/80 | 4 | 4 | 4 | 4 | 4 | 4 | 4 | 3 | 3 | 3 | 3 | 3 | 3 | 2 | 2 | 2 | 2 | 2 | 2 | 2 | 2 |
| 5/95 | 3 | 3 | 3 | 3 | 3 | 3 | 3 | 3 | 2 | 2 | 2 | 2 | 2 | 2 | 2 | 2 | 2 | 2 | 2 | 2 | 2 |

TABLE 13
Miscibility data for 50% Krytox ® FSL/50% POE RL32H with HFO-1234yv refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 1 | 1 | 1 | 1 | 1 | 1 | 1 | 1 | 1 | 1 | 1 | 1 | 1 | 1 | 1 | 1 | 1 | 1 | 1 | 1 | 1 |
| 50/50 | 1 | 1 | 1 | 1 | 1 | 1 | 1 | 1 | 1 | 1 | 1 | 1 | 1 | 1 | 1 | 1 | 1 | 1 | 1 | 1 | 1 |
| 40/60 | 1 | 1 | 1 | 1 | 1 | 1 | 1 | 1 | 1 | 1 | 1 | 1 | 1 | 1 | 1 | 1 | 1 | 1 | 1 | 1 | 1 |
| 30/70 | 3 | 3 | 3 | 3 | 3 | 3 | 3 | 3 | 3 | 2 | 2 | 2 | 2 | 2 | 2 | 2 | 2 | 2 | 2 | 2 | 2 |
| 20/80 | 3 | 3 | 3 | 3 | 3 | 3 | 3 | 3 | 3 | 3 | 3 | 2 | 2 | 2 | 2 | 2 | 2 | 2 | 2 | 2 | 2 |
| 5/95 | 3 | 3 | 3 | 3 | 3 | 3 | 3 | 3 | 3 | 3 | 3 | 3 | 3 | 3 | 3 | 3 | 3 | 2 | 2 | 2 | 2 |

TABLE 14
Miscibility data for 75% Krytox ® FS/25% POE RL 32 H with HFO-1234yv refrigerant.

| 1234yf/ | Number of Phases at a Given Temperature | | | | | | | | | | | | | | | | | | | | |
|---|---|---|---|---|---|---|---|---|---|---|---|---|---|---|---|---|---|---|---|---|---|
| lubricant | Temperature | | | | | | | | | | | | | | | | | | | | |
| (vol %) | −40 | −35 | −30 | −25 | −20 | −15 | −10 | −5 | 0 | 5 | 10 | 15 | 20 | 25 | 30 | 35 | 40 | 45 | 50 | 55 | 60 |
| 95/5 | 1 | 1 | 1 | 1 | 1 | 1 | 1 | 1 | 1 | 1 | 1 | 1 | 1 | 1 | 1 | 1 | 1 | 1 | 1 | 1 | 1 |
| 90/10 | 1 | 1 | 1 | 1 | 1 | 1 | 1 | 1 | 1 | 1 | 1 | 1 | 1 | 1 | 1 | 1 | 1 | 1 | 1 | 1 | 1 |
| 75/25 | 1 | 1 | 1 | 1 | 1 | 1 | 1 | 1 | 1 | 1 | 1 | 1 | 1 | 1 | 1 | 1 | 1 | 1 | 1 | 1 | 1 |
| 50/50 | 1 | 1 | 1 | 1 | 1 | 1 | 1 | 1 | 1 | 1 | 1 | 1 | 1 | 1 | 1 | 1 | 1 | 1 | 1 | 1 | 1 |
| 40/60 | 2 | 2 | 2 | 1 | 1 | 1 | 1 | 1 | 1 | 1 | 1 | 1 | 1 | 1 | 1 | 1 | 1 | 1 | 1 | 1 | 1 |
| 30/70 | 2 | 2 | 2 | 2 | 2 | 2 | 2 | 1 | 1 | 1 | 1 | 1 | 1 | 1 | 1 | 1 | 1 | 1 | 1 | 1 | 1 |
| 20/80 | 2 | 2 | 2 | 2 | 2 | 2 | 2 | 2 | 2 | 1 | 1 | 1 | 1 | 2 | 2 | 1 | 1 | 1 | 1 | 1 | 1 |
| 5/95 | 3 | 3 | 3 | 3 | 3 | 3 | 3 | 3 | 3 | 3 | 3 | 3 | 3 | 3 | 3 | 3 | 3 | 3 | 2 | 2 | 2 |

The results show there are many compositions of R-1234yf refrigerant, Krytox®, and PAG or POE lubricant where one or two phases was achieved demonstrating improved miscibility versus compositions where three phases were observed. The results indicate refrigerant/lubricant mixtures of the present invention can be used as pairs for cooling, heating and power generation equipment. In one case shown in Table 8, complete miscibility was achieved over the entire temperature and refrigerant/lubricant composition range.

### Example 2

### Viscosity

To select the preferred PFPE lubricant to replace a PAG or POE, lubricant it is important to determine the viscosity of the refrigerant/lubricant mixture at compressor sump conditions during refrigeration or air conditioning operation. Vapor-Liquid equilibria, pressure and viscosity data were measured for PAG and POE lubricants with HFO-1234yf and compared to HFO-1234yf and different PFPE lubricants. The viscosity was determined for the refrigerant-lubricant mixtures at typical compressor sump conditions of 20° C. and 0.35 MPa using a ViscoPro 2000 Viscometer (Cambridge Applied Systems, Medford, Mass., USA). Results are shown below.

TABLE 15

| | Dynamic Refrigerant- | Wt % Refrigerant |
|---|---|---|
| HFO-1234yf | Lubricant Viscosity at | Dissolved in |
| plus | 20° C. and 0.35 MPa (cP) | Lubricant |
| PAG PSD1 | 3.0 | 28 |
| POE 22 | 1.8 | 24 |
| POE 32 | 2.0 | 22 |
| POE 68 | 3.0 | 18 |
| GPL 104 | 3.0 | 16 |
| GPL 105 | 1.1 | 9 |
| GPL 106 | 5.0 | 8 |
| 157 FS(L) | 5.5 | 15 |

The data show for PAG PSD1, the closest match in viscosity is Krytox® GPL 104, both with a viscosity at 3 cP. GPL-104 is also the best choice in that it either matches the viscosity or is slightly higher than the POE lubricant it is replacing, which is one parameter in selecting a lubricant to provide adequate lubrication to the compressors.

### Example 3

### More Miscibility Data

Lubricant mixtures were tested for miscibility in the presence of a refrigerant by the following method. Refrigerant and lubricant mixture compositions were loaded into sealed glass tubes at varying refrigerant and lubricant concentrations by volume. For this example, Z-HFO-1336mzz refrigerant or a mixture of Z-HFO-1336mzz and HFC-245eb, one PFPE lubricant and one non-fluorinated lubricant were loaded in the tubes. The tubes were then subjected to different temperatures and observed visually for the number of phases present. If one phase was observed, the refrigerant and two lubricants achieved complete miscibility. If three phases were observed, there was no miscibility achieved between any of the phases. It is desirable to have one or two phases showing improvement in miscibility. Results are shown in Tables 16 through 19. Table 16 shows miscibility data for pure POE with Z-HFO-1336mzz refrigerant. Table 17 shows miscibility data for GPL 104/POE/Z-HFO-1336mzz refrigerant; Table 18 shows miscibility data for pure POE with mixed Z-HFO-1336mzz/HFC-245eb refrigerant; and Table 19 shows miscibility data for GPL 104/POE/ with mixed Z-HFO-1336mzz/HFC-245eb refrigerant.

TABLE 16
Miscibility data for POE (York L) lubricant
with Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 1 | 1 | 1 | 1 | 1 | 1 | 1 | 2 | 2 | 2 |

TABLE 17
Miscibility data for 50% Krvtox GPL 104/50% POE (York
L) lubricant with Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 2 | 2 | 2 | 2 | 2 | 3 | 3 | 3 | 3 | 3 |

TABLE 18
Miscibility data for POE (York L) lubricant with
Z-HFO-1336mzz/HFC-245eb 50/50% refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 1 | 1 | 1 | 1 | 1 | 1 | 1 | 2 | 2 | 2 |

TABLE 19
Miscibility data for 50% Krytox GPL 104/50% POE (York L) lubricant
with 50% Z-HFO-1336mzz/50% HFC-245eb refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 2 | 2 | 2 | 2 | 2 | 3 | 3 | 3 | 3 | 3 |

### Example 4

### Addition of HFO Increases the Miscibility of Krytox®/POE Blends

Table 20 shows the number of distinct phases to which a blend consisting of 50% York L POE lubricant and 50% Krytox® FSL separates at equilibrium at various temperatures. Two immiscible phases, occupying a top and a bottom layer of approximately equal volumes in the sealed glass test tube, remained throughout the temperature range tested. The Krytox®-rich bottom phase remained clear and transparent throughout the temperature range tested. The top phase, rich in York L, had a cloudy appearance at all temperatures tested, consistent with the presence of droplets of Krytox® dispersed in a continuous phase of York L.

TABLE 20
Miscibility data for 50% Krytox ® FSL/50%
POE (York L) lubricant (no refrigerant added)

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 0/100 | 2 | 2 | 2 | 2 | 2 | 2 | 2 | 2 | 2 | 2 |

Table 21 shows the number of distinct phases to which a blend consisting of 50% Z-HFO-1336mzz refrigerant and 50% lubricant, where said lubricant consists of 50% York L POE lubricant and 50 wt % Krytox® FSL, separates at equilibrium at various temperatures. Table 21 indicates that a homogenous mixture is maintained at temperatures up to 60° C. A comparison of Table 21 to Table 20 indicates that the addition of Z-HFO-1336mzz to the York L/Krytox® FSL blend improved the miscibility of the York L/Krytox FSL blend at temperatures between room temperature and 60° C. Moreover, the amount of the HFO-1336mzz-Z/Krytox® FSL/York L blend separating as a second phase at temperatures between 70 and 95° C., shown in Table 21, is much smaller than in the case of the Krytox® FSL/York L blend (without Z-HFO-1336mzz) over the same temperature range, as shown in Table 20.

TABLE 21
Miscibility data for 50% Krytox ® FSL/50% POE
(York L) lubricant 100% Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 1 | 1 | 1 | 2^{(a)} | 2^{(a)} | 2^{(a)} | 2^{(a)} | 2^{(b)} | 3 | 3 |

^{(a)}thin immiscible layer at top of tube 2 (3 mm thick)
^{(b)}thin immiscible layer at top of tube 5 (6 mm thick)

### Example 5

HFO refrigerants can have adequate miscibility with Krytox®/POE lubricant blends to be used as working fluid/lubricant pairs for cooling, heating and power generation equipment

Cooling, heating and power generation equipment, such as chillers, heat pumps and organic Rankine power engines, usually require a refrigerant and a lubricant for their operation. The refrigerant and the lubricant must be adequately miscible to allow efficient operation and ensure long equipment life. The data in Table 21 indicate that a blend consisting of Z-HFO-1336mzz as the refrigerant and a blend consisting of 50% York L POE and 50% Krytox® FSL as the lubricant remains adequately miscible over a wide temperature range to be used in cooling, heating and power generation equipment.

The data in Table 22 indicate that the three component mixture consisting of 90% Z-HFO-1336mzz, 2.5% Krytox® GPL 104 and 7.5% York L POE remained fully miscible throughout the temperature range tested. Therefore, Z-HFO-1336mzz and a blend consisting of 75% York L POE and 25% Krytox® GPI 104 could remain adequately miscible over a wide temperature range to be used as the refrigerant and the lubricant, respectively, in cooling, heating and power generation equipment.

TABLE 22
Miscibility data for 25% Krytox ® GPL 104/75% POE
(York L) lubricant 100% Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 90/10 | 1 | 1 | 1 | 1 | 1 | 1 | 1 | 1 | 1 | 1 |

The data in Table 23 indicate that the three component mixture consisting of 90% Z-HFO-1336mzz, 2.5% Krytox® FSL and 7.5% York L POE remained fully miscible throughout the temperature range tested. The data in Table 24 indicate that the three component mixture consisting of 50% Z-HFO-1336mzz, 12.5% Krytox® FSL and 37.5% York L POE remained either fully miscible or separated only to a limited extend over a temperature range useful for cooling, heating or power generation applications. Therefore, Z-HFO-1336mzz and a blend consisting of 75% York L POE and 25% Krytox® FSL could remain adequately miscible over a wide temperature range to be used as the refrigerant and the lubricant, respectively, in cooling, heating and power generation equipment.

TABLE 23
Miscibility data for 25% Krytox ® FSL/75% POE
(York L) lubricant 100% Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 90/10 | 1 | 1 | 1 | 1 | 1 | 1 | 1 | 1 | 1 | 1 |

TABLE 24
Miscibility data for 25% Krytox ® FSL/75% POE
(York L) lubricant 100% Z-HFO-1336mzz refrigerant.

| | Number of Phases at a Given Temperature | | | | | | | | | |
|---|---|---|---|---|---|---|---|---|---|---|
| Refrigerant/ | Temperature (° C.) | | | | | | | | | |
| Lubricant | Room | | | | | | | | | |
| (vol %) | Temp | 50 | 60 | 70 | 80 | 85 | 90 | 95 | 100 | 105 |
| 50/50 | 1 | 1 | 1 | 1 | 2^{(a)} | 2^{(a)} | 2^{(a)} | 2^{(b)} | 4 | 3 |

^{(a)}thin immiscible layer at top of tube (3 mm thick)
^{(b)}thin immiscible layer at top of tube (6 mm thick)

### SELECTED EMBODIMENTS

### Embodiment A1

A method to improve miscibility in refrigeration, air conditioning, or heat pump systems comprising:
charging a refrigeration, air conditioning, or heat pump system with a refrigerant composition;
wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +200° C.; and
wherein the refrigeration, air conditioning, or heat pump system comprises an evaporator, a condenser, a compressor and an expansion device.

### Embodiment A1a

The method of Embodiment A1, wherein the refrigerant composition has no more than two liquid phases over a temperature from about −40° C. to about +160.

### Embodiment A1b

The method of Embodiment A1, wherein the refrigerant composition has no more than two liquid phases over a temperature from about −40° C. to about +105.

### Embodiment A1c

The method of Embodiment A1, wherein the refrigerant composition has no more than two liquid phases over a temperature from about −40° C. to about +60.

### Embodiment A2

The method of Embodiment A1, wherein the at least one refrigerant comprises at least one compound selected from the group consisting of saturated hydrocarbons, unsaturated hydrocarbons, saturated fluorocarbons, unsaturated fluorocarbons, and combinations thereof.

### Embodiment A3

The method of any of Embodiments A1-A2, wherein the at least one refrigerant comprises a saturated or unsaturated hydrocarbon.

### Embodiment A4

The method of any of Embodiments A1-A2, wherein the at least one refrigerant comprises a saturated fluorocarbon.

### Embodiment A5

The method of any of Embodiments A1-A2, wherein the at least one refrigerant comprises an unsaturated fluorocarbon.

### Embodiment A6

The method of any of Embodiments A1, or A4-A5, wherein the at least one refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

### Embodiment A7

The method of any of Embodiments A1-A6, wherein the at least one refrigerant comprises HFO-1234yf.

### Embodiment A8

The method of any of Embodiments A1-A6, wherein the at least one refrigerant comprises trans-HFO-1234ze.

### Embodiment A9

The method of any of Embodiments A1-A6, wherein the at least one refrigerant comprises HFC-32.

### Embodiment A10

The method of any of Embodiments A1-A6, wherein the at least one refrigerant comprises HFC-152a.

### Embodiment A11

The method of any of Embodiments A1-A10, wherein the perfluoropolyether has viscosity in the range of about 5 to about 1000 cSt at 40° C.

### Embodiment A12

The method of any of Embodiments A1-A11, wherein the perfluoropolyether has viscosity in the range of about 20 to about 100 cSt at 40° C.

### Embodiment A13

The method of any of Embodiments A1-A12, wherein the perfluoropolyether has viscosity in the range of about 30 to about 90 cSt at 40° C.

### Embodiment A14

The method of any of Embodiments A1-A13, wherein the perfluoropolyether is non-functionalized.

### Embodiment A15

The method of any of Embodiments A1-A14, wherein at least one of the end groups of the perfluoropolyether is a functionalized group selected from the group consisting of esters, hydroxyls, amines, amides, cyanos, carboxylic acids and sulfonic acids.

### Embodiment A16

The method of any of Embodiments A1-A15, wherein at least one of the end groups of the perfluoropolyether is a carboxylic acid.

### Embodiment A17

The method of any of Embodiments A1-A16, wherein the ratio of refrigerant to lubricant is in a range of 99:1 to 1:99.

### Embodiment A18

The method of any of Embodiments A1-A17, wherein the ratio of perfluoropolyether to non-fluorinated lubricant is in a range of about 5:95 to 99:1.

### Embodiment A19

The method of any of Embodiments A1-A18, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

### Embodiment A20

The method of any of Embodiments A1-A19, wherein the non-fluorinated lubricant is a polyalkylene glycol.

### Embodiment A21

The method of any of Embodiments A1-A20, wherein the non-fluorinated lubricant is a polyol ester.

### Embodiment A22

The method of any of Embodiments A1-A21, wherein the non-fluorinated lubricant is a polyvinyl ether.

### Embodiment A23

The method of any of Embodiments A1-A22, wherein the refrigerant composition has a single liquid phase over the range of the composition and over a range of temperature from about −40° C. to about +200° C.

### Embodiment A23a

The method of Embodiment A23, wherein the refrigerant composition has a single liquid phase over a temperature from about −40° C. to about +160.

### Embodiment A23b

The method of Embodiment A23, wherein the refrigerant composition has a single liquid phase over a temperature from about −40° C. to about +105.

### Embodiment A23c

The method of Embodiment A23, wherein the refrigerant composition has a single liquid phase over a temperature from about −40° C. to about +60.

### Embodiment A24

The method of any of Embodiments A1-A23, wherein the refrigerant composition has a single liquid phase over the range of the composition and over a range of temperature from about −20° C. to about +40° C.

### Embodiment A25

The method of any of Embodiments A1-A24, wherein the refrigerant composition has a single liquid phase over the range of the composition and over a range of temperature from about 5° C. to about 25° C.

### Embodiment A26

The method of any of Embodiments A1-A25, wherein the ratio of perfluoropolyether to non-fluorinated lubricant is in a range of about 5:95 to 20:80.

### Embodiment B1

A refrigeration, air conditioning, or heat pump system comprising an evaporator, a condenser, a compressor and an expansion device; wherein the refrigeration or air conditioning system contains a refrigerant composition comprising at least one refrigerant and a lubricant; wherein the lubricant comprises at least one perfluoropolyether and a non-fluorinated lubricant, provided that the refrigerant composition has no more than two liquid phases over the range of the composition and over a range of temperature from about −40° C. to about +200° C.

### Embodiment B1a

The refrigeration, air conditioning, or heat pump system of Embodiment B1, wherein the refrigerant composition has no more than two liquid phases over a temperature from about −40° C. to about +160.

### Embodiment B1b

The refrigeration, air conditioning, or heat pump system of Embodiment B1, wherein the refrigerant composition has no more than two liquid phases over a temperature from about −40° C. to about +105.

### Embodiment B1c

The refrigeration, air conditioning, or heat pump system of Embodiment B1, wherein the refrigerant composition has no more than two liquid phases over a temperature from about −40° C. to about +60.

### Embodiment B2

The refrigeration, air conditioning, or heat pump system of Embodiment B1 that is an automobile air conditioning system.

### Embodiment B3

The refrigeration, air conditioning, or heat pump system of Embodiment B1 that is a stationary refrigeration, air conditioning, or heat pump system.

### Embodiment B4

The refrigeration, air conditioning, or heat pump system of any of Embodiments B1 or B3 that is a stationary air conditioning system.

### Embodiment B5

The refrigeration, air conditioning, or heat pump system of any of Embodiments B1 or B3 that is a stationary refrigeration system.

### Embodiment B6

The refrigeration, air conditioning, or heat pump system of any of Embodiments B1-B5, wherein the at least one refrigerant comprises at least one compound selected from the group consisting of saturated hydrocarbon, unsaturated hydrocarbons, saturated fluorocarbons, unsaturated fluorocarbons, and combinations thereof.

### Embodiment B7

The refrigeration, air conditioning, or heat pump system of any of Embodiments B1-B6, wherein the at least one refrigerant comprises a saturated or unsaturated hydrocarbon.

### Embodiment B8

The refrigeration, air conditioning, or heat pump system of any of Embodiments B1-B6, wherein the at least one refrigerant comprises a saturated fluorocarbon.

### Embodiment B9

The refrigeration, air conditioning, or heat pump system of any of Embodiments B1-B6, wherein the at least one refrigerant comprises an unsaturated fluorocarbon.

### Embodiment B10

The refrigeration, air conditioning, or heat pump system of any of Embodiments B1-B9, wherein the at least one refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

### Embodiment B11

The refrigeration, air conditioning, or heat pump system of any of Embodiments B1-B10, wherein the at least one refrigerant comprises HFO-1234yf.

### Embodiment B12

The refrigeration, air conditioning, or heat pump system of any of Embodiments B1-B11, wherein the at least one refrigerant comprises trans-HFO-1234ze.

### Embodiment B13

The refrigeration, air conditioning, or heat pump system of any of Embodiments B1-B11, wherein the at least one flammable compound comprises HFC-32.

### Embodiment B14

The refrigeration, air conditioning, or heat pump system of any of Embodiments B1-B11, wherein the at least one compound comprises HFC-152a.

### Embodiment B15

The refrigeration, air conditioning, or heat pump system of any of Embodiments B1-B14, wherein the perfluoropolyether has viscosity in the range of about 5 to about 1000 cSt at 40° C.

### Embodiment B16

The refrigeration, air conditioning, or heat pump system of any of Embodiments B1-B15, wherein the perfluoropolyether has viscosity in the range of about 20 to about 100 cSt at 40° C.

### Embodiment B17

The refrigeration, air conditioning, or heat pump system of any of Embodiments B1-B16, wherein the perfluoropolyether has viscosity in the range of about 20 to about 80 cSt at 40° C.

### Embodiment B18

The refrigeration, air conditioning, or heat pump system of any of Embodiments B1-B17, wherein the perfluoropolyether is non-functionalized.

### Embodiment B19

The refrigeration, air conditioning, or heat pump system of any of Embodiments B1-B18, wherein at least one of the end groups of the perfluoropolyether is a functionalized group selected from the group consisting of esters, hydroxyls, amines, amides, cyanos, carboxylic acids and sulfonic acids.

### Embodiment B20

The refrigeration, air conditioning, or heat pump system of any of Embodiments B1-B19, wherein at least one of the end groups of the perfluoropolyether is a carboxylic acid.

### Embodiment B21

The refrigeration, air conditioning, or heat pump system of any of Embodiments B1-B20, wherein the ratio of refrigerant to lubricant is in a range of 99:1 to 1:99.

### Embodiment B22

The refrigeration, air conditioning, or heat pump system of any of Embodiments B1-B4, wherein the ratio of perfluoropolyether to non-fluorinated lubricant is in a range of about 5:95 to 99:1.

### Embodiment B23

The refrigeration, air conditioning, or heat pump system of any of Embodiments B1-B22, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

### Embodiment B24

The refrigeration, air conditioning, or heat pump system of any of Embodiments B1-B23, wherein the non-fluorinated lubricant is a polyalkylene glycol.

### Embodiment B25

The refrigeration, air conditioning, or heat pump system of any of Embodiments B1-B24, wherein the non-fluorinated lubricant is a polyol ester.

### Embodiment B26

The refrigeration, air conditioning, or heat pump system of any of Embodiments B1-B25, wherein the non-fluorinated lubricant is a polyvinyl ether.

### Embodiment B27

The refrigeration, air conditioning, or heat pump system of any of Embodiments B1-B26, wherein the refrigerant composition has a single liquid phase over the range of the composition and over a range of temperature from about −40° C. to about +200° C.

### Embodiment B27a

The refrigeration, air conditioning, or heat pump system of Embodiment B27, wherein the refrigerant composition has a single liquid phase over a temperature from about −40° C. to about +160.

### Embodiment B27b

The refrigeration, air conditioning, or heat pump system of Embodiment B27, wherein the refrigerant composition has a single liquid phase over a temperature from about −40° C. to about +105.

### Embodiment B27c

The refrigeration, air conditioning, or heat pump system of Embodiment B27, wherein the refrigerant composition has a single liquid phase over a temperature from about −40° C. to about +60.

### Embodiment B28

The refrigeration, air conditioning, or heat pump system of any of Embodiments B1-B27, wherein the refrigerant composition has a single liquid phase over the range of the composition and over a range of temperature from about 5° C. to about 25° C.

### Embodiment B29

The refrigeration, air conditioning, or heat pump system of any of Embodiments B1-B28, wherein the refrigerant composition has a single liquid phase over the range of the composition and over a range of temperature from about 5° C. to about 25° C.

### Embodiment B30

The refrigeration, air conditioning, or heat pump system of any of Embodiments B1-B29, wherein the ratio of perfluoropolyether to non-fluorinated lubricant is in a range of about 5:95 to 20:80.

### Embodiment C1

A method to improve miscibility in power cycle systems comprising charging a power cycle system with a refrigerant composition; wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +300° C.; and wherein the power cycle system comprises a working fluid heating unit, an expander, a working fluid cooling unit and a compressor.

### Embodiment C1a

The method of Embodiment C1, wherein the refrigerant composition has no more than two liquid phases over a temperature from about −40° C. to about +250.

### Embodiment C1b

The method of Embodiment C1, wherein the refrigerant composition has no more than two liquid phases over a temperature from about −40° C. to about +105.

### Embodiment C1c

The method of Embodiment C1, wherein the refrigerant composition has no more than two liquid phases over a temperature from about −40° C. to about +60.

### Embodiment C2

The method of Embodiment C1, wherein the power cycle system is an organic Rankine cycle system.

### Embodiment C3

The method of any of Embodiments C1-C2, wherein the at least one refrigerant comprises at least one compound selected from the group consisting of saturated hydrocarbons, unsaturated hydrocarbons, saturated fluorocarbons, unsaturated fluorocarbons, and combinations thereof.

### Embodiment C4

The method of any of Embodiments C1-C3, wherein the at least one refrigerant comprises a saturated or unsaturated hydrocarbon.

### Embodiment C5

The method of any of Embodiments C1-C3, wherein the at least one refrigerant comprises a saturated fluorocarbon.

### Embodiment C6

The method of any of Embodiments C1-C3, wherein the at least one refrigerant comprises an unsaturated fluorocarbon.

### Embodiment C7

The method of any of Embodiments C1-C6, wherein the at least one refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

### Embodiment C8

The method of any of Embodiments C1-C7, wherein the at least one refrigerant comprises HFO-1234yf.

### Embodiment C9

The method of any of Embodiments C1-C8, wherein the at least one refrigerant comprises trans-HFO-1234ze.

### Embodiment C10

The method of any of Embodiments C1-C9, wherein the at least one refrigerant comprises HFC-32.

### Embodiment C11

The method of any of Embodiments C1-C10, wherein the at least one refrigerant comprises HFC-152a.

### Embodiment C12

The method of any of Embodiments C1-C11, wherein the at least one refrigerant comprises HFC-134.

### Embodiment C13

The method of any of Embodiments C1-C11, wherein the at least one refrigerant comprises E-HFO-1336mzz or Z-HFO-1336mzz.

### Embodiment C14

The method of any of Embodiments C1-C13, wherein the at least one refrigerant comprises E-HCFO-1233zd or Z-HCFO-1233zd.

### Embodiment C15

The method of any of Embodiments C1-C14, wherein the perfluoropolyether has viscosity in the range of about 5 to about 1000 cSt at 40° C.

### Embodiment C16

The method of any of Embodiments C1-C15, wherein the perfluoropolyether has viscosity in the range of about 20 to about 100 cSt at 40° C.

### Embodiment C17

The method of any of Embodiments C1-C16, wherein the perfluoropolyether has viscosity in the range of about 30 to about 90 cSt at 40° C.

### Embodiment C18

The method of any of Embodiments C1-C17, wherein the perfluoropolyether is non-functionalized.

### Embodiment C19

The method of any of Embodiments C1-C18, wherein at least one of the end groups of the perfluoropolyether is a functionalized group selected from the group consisting of esters, hydroxyls, amines, amides, cyanos, carboxylic acids and sulfonic acids.

### Embodiment C20

The method of any of Embodiments C1-C19, wherein at least one of the end groups of the perfluoropolyether is a carboxylic acid.

### Embodiment C21

The method of any of Embodiments C1-C20, wherein the ratio of refrigerant to lubricant is in a range of 99:1 to 1:99.

### Embodiment C22

The method of any of Embodiments C1-C21, wherein the ratio of perfluoropolyether to non-fluorinated lubricant is in a range of about 5:95 to 99:1.

### Embodiment C23

The method of any of Embodiments C1-C22, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

### Embodiment C24

The method of any of Embodiments C1-C23, wherein the non-fluorinated lubricant is a polyalkylene glycol.

### Embodiment C25

The method of any of Embodiments C1-C24, wherein the non-fluorinated lubricant is a polyol ester.

### Embodiment C26

The method of any of Embodiments C1-C25, wherein the non-fluorinated lubricant is a polyvinyl ether.

### Embodiment C27

The method of any of Embodiments C1-C26, wherein the refrigerant composition has a single liquid phase over the range of the composition and over a range of temperature from about −40° C. to about +300° C.

### Embodiment C27a

The method of Embodiment C27, wherein the refrigerant composition has a single liquid phase over a temperature from about −40° C. to about +250.

### Embodiment C27b

The method of Embodiment C27, wherein the refrigerant composition has a single liquid phase over a temperature from about −40° C. to about +105.

### Embodiment C27c

The method of Embodiment C27, wherein the refrigerant composition has a single liquid phase over a temperature from about −40° C. to about +60.

### Embodiment C28

The method of any of Embodiments C1-C27, wherein the refrigerant composition has a single liquid phase over the range of the composition and over a range of temperature from about −20° C. to about +40° C.

### Embodiment C29

The method of any of Embodiments C1-C28, wherein the refrigerant composition has a single liquid phase over the range of the composition and over a range of temperature from about 5° C. to about 25° C.

### Embodiment C30

The method of any of Embodiments C1-C29, wherein the ratio of perfluoropolyether to non-fluorinated lubricant is in a range of about 5:95 to 20:80.

### Embodiment D1

A power cycle system comprising a working fluid heating unit, an expander, a working fluid cooling unit and a compressor; wherein the power cycle system contains a refrigerant composition comprising at least one refrigerant and a lubricant, wherein the lubricant comprises at least one perfluoropolyether and a non-fluorinated lubricant, provided that the refrigerant composition has no more than two liquid phases over the range of the composition and over a range of temperature from about −40° C. to about +300° C.

### Embodiment D1a

The power cycle system of Embodiment D1, wherein the refrigerant composition has no more than two liquid phases over a temperature from about −40° C. to about +250.

### Embodiment D1 b

The power cycle system of Embodiment D1, wherein the refrigerant composition has no more than two liquid phases over a temperature from about −40° C. to about +105.

### Embodiment D1c

The power cycle system of Embodiment D1, wherein the refrigerant composition has no more than two liquid phases over a temperature from about −40° C. to about +60.

### Embodiment D2

The power cycle system of Embodiment D1 that is an organic Rankine cycle system.

### Embodiment D3

The power cycle system of any of Embodiments D1-D2, wherein the at least one refrigerant comprises at least one compound selected from the group consisting of saturated hydrocarbon, unsaturated hydrocarbons, saturated fluorocarbons, unsaturated fluorocarbons, and combinations thereof.

### Embodiment D4

The power cycle system of any of Embodiments D1-D3, wherein the at least one refrigerant comprises a saturated or unsaturated hydrocarbon.

### Embodiment D5

The power cycle system of any of Embodiments D1-D4, wherein the at least one refrigerant comprises a saturated fluorocarbon.

### Embodiment D6

The power cycle system of any of Embodiments D1-D5, wherein the at least one refrigerant comprises an unsaturated fluorocarbon.

### Embodiment D7

The power cycle system of any of Embodiments D1-D6, wherein the at least one refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

### Embodiment D8

The power cycle system of any of Embodiments D1-D7, wherein the at least one refrigerant comprises HFO-1234yf.

### Embodiment D9

The power cycle system of any of Embodiments D1-D8, wherein the at least one refrigerant comprises trans-HFO-1234ze.

### Embodiment D10

The power cycle system of any of Embodiments D1-D9, wherein the at least one flammable compound comprises HFC-32.

### Embodiment D11

The power cycle system of any of Embodiments D1-D10, wherein the at least one compound comprises HFC-152a.

### Embodiment D12

The power cycle of any of Embodiments D1-D11, wherein the at least one refrigerant comprises HFC-134.

### Embodiment D13

The power cycle of any of Embodiments D1-D12, wherein the at least one refrigerant comprises E-HFO-1336mzz or Z-HFO-1336mzz.

### Embodiment D14

The power cycle of any of Embodiments D1-D13, wherein the at least one refrigerant comprises E-HCFO-1233zd or Z-HCFO-1233zd.

### Embodiment D15

The power cycle system of any of Embodiments D1-D14, wherein the perfluoropolyether has viscosity in the range of about 5 to about 1000 cSt at 40° C.

### Embodiment D16

The power cycle system of any of Embodiments D1-D15, wherein the perfluoropolyether has viscosity in the range of about 20 to about 100 cSt at 40° C.

### Embodiment D17

The power cycle system of any of Embodiments D1-D16, wherein the perfluoropolyether has viscosity in the range of about 20 to about 80 cSt at 40° C.

### Embodiment D18

The power cycle system of any of Embodiments D1-D17, wherein the perfluoropolyether is non-functionalized.

### Embodiment D19

The power cycle system of any of Embodiments D1-D18, wherein at least one of the end groups of the perfluoropolyether is a functionalized group selected from the group consisting of esters, hydroxyls, amines, amides, cyanos, carboxylic acids and sulfonic acids.

### Embodiment D20

The power cycle system of any of Embodiments D1-D19, wherein at least one of the end groups of the perfluoropolyether is a carboxylic acid.

### Embodiment D21

The power cycle system of any of Embodiments D1-D20, wherein the ratio of refrigerant to lubricant is in a range of 99:1 to 1:99.

### Embodiment D22

The power cycle system of any of Embodiments D1-D21, wherein the ratio of perfluoropolyether to non-fluorinated lubricant is in a range of about 5:95 to 99:1.

### Embodiment D23

The power cycle system of any of Embodiments D1-D22, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

### Embodiment D24

The power cycle system of any of Embodiments D1-D23, wherein the non-fluorinated lubricant is a polyalkylene glycol.

### Embodiment D25

The power cycle system of any of Embodiments D1-D24, wherein the non-fluorinated lubricant is a polyol ester.

### Embodiment D26

The power cycle system of any of Embodiments D1-D25, wherein the non-fluorinated lubricant is a polyvinyl ether.

### Embodiment D27

The power cycle system of any of Embodiments D1-D26, wherein the refrigerant composition has a single liquid phase over the range of the composition and over a range of temperature from about −40° C. to about +60° C.

### Embodiment D28

The power cycle system of any of Embodiments D1-D27, wherein the refrigerant composition has a single liquid phase over the range of the composition and over a range of temperature from about 5° C. to about 25° C.

### Embodiment D29

The power cycle system of any of Embodiments D1-D28, wherein the refrigerant composition has a single liquid phase over the range of the composition and over a range of temperature from about 5° C. to about 25° C.

### Embodiment D30

The power cycle system of any of Embodiments D1-D29, wherein the ratio of perfluoropolyether to non-fluorinated lubricant is in a range of about 5:95 to 20:80.

What is claimed is:

1. A method to improve miscibility in refrigeration, air conditioning, or heat pump systems comprising:
charging a refrigeration, air conditioning, or heat pump system with a refrigerant composition;
wherein the refrigerant composition comprises at least one refrigerant and a lubricant; wherein the lubricant comprises at least one perfluoropolyether and at least one non-fluorinated lubricant, provided that the refrigerant composition has no more than two liquid phases over the range of the composition and over a range of temperature from about −40° C. to about +200° C.; and
wherein the refrigeration, air conditioning, or heat pump system comprises an evaporator, a condenser, a compressor and an expansion device.

2. The method of claim 1, wherein the at least one refrigerant comprises at least one compound selected from the group consisting of HFO-1234yf and trans-HFO-1234ze; and wherein the non-fluorinated lubricant comprises polyalkylene glycols.

3. The method of claim 1, wherein the at least one refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

4. The method of claim 1, wherein the perfluoropolyether has viscosity in the range of about 5 to about 1000 cSt at 40° C.

5. The method of claim 1, wherein the perfluoropolyether is non-functionalized.

6. The method of claim 1, wherein at least one of the end groups of the perfluoropolyether is a functionalized group selected from the group consisting of esters, hydroxyls, amines, amides, cyanos, carboxylic acids and sulfonic acids.

7. The method of claim 1, wherein the ratio of refrigerant to lubricant is in a range of 99:1 to 1:99.

8. The method of claim 1, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

9. The method of claim 1, wherein the refrigerant composition has a single liquid phase over the range of the composition and over a range of temperature from about −40° C. to about +200° C.

10. A refrigeration, air conditioning or heat pump system comprising an evaporator, a condenser, a compressor and an expansion device; wherein the refrigeration, air conditioning or heat pump system contains a refrigerant composition comprising at least one flammable refrigerant and a lubricant, wherein the lubricant comprises at least one perfluoropolyether and a non-fluorinated lubricant, provided that the refrigerant composition has no more than two liquid phases over the range of the composition and over a range of temperature from about −40° C. to about +200° C.

11. The refrigeration, air conditioning or heat pump system of claim 10 that is an automobile air conditioning system.

12. The refrigeration, air conditioning or heat pump system of claim 10 that is a stationary refrigeration, air conditioning, or heat pump system.

13. The refrigeration, air conditioning or heat pump system of claim 10, wherein the at least one refrigerant comprises at least one compounds selected from the group consisting of HFO-1234yf and trans-HFO-1234ze; and wherein the non-fluorinated lubricant comprises polyalkylene glycols.

14. The refrigeration, air conditioning or heat pump system of claim 10, wherein the at least one flammable refrigerant is chosen from HFO-1234yf, trans-HFO-1234ze, HFO-1243zf, HFC-32, HFC-134, HFC-134a, HFC-125, HFC-152a, HFC-161, HFC-227ea, HFC-236fa, HFC-245fa, HFC-245eb, HFC-245cb, Z-HFO-1336mzz, E-HFO-1336mzz, HFO-1233zd and combinations of two or more thereof.

15. The refrigeration, air conditioning or heat pump system of claim 10, wherein the perfluoropolyether has viscosity in the range of about 5 to about 1000 cSt at 40° C.

16. The refrigeration, air conditioning or heat pump system of claim 10, wherein the perfluoropolyether is non-functionalized.

17. The refrigeration, air conditioning or heat pump system of claim 10, wherein at least one of the end groups of the perfluoropolyether is a functionalized group selected from the group consisting of esters, hydroxyls, amines, amides, cyanos, carboxylic acids and sulfonic acids.

18. The refrigeration, air conditioning or heat pump system of claim 10, wherein the ratio of refrigerant to lubricant is in a range of 99:1 to 1:99.

19. The refrigeration, air conditioning or heat pump system of claim 10, wherein the non-fluorinated lubricant is selected from the group consisting of mineral oils, alkylbenzenes, polyalphaolefins, polyol esters, polyalkylene glycols, polyvinyl ethers, polycarbonates, silicones and combinations of two or more thereof.

20. The refrigeration, air conditioning or heat pump system of claim 10, wherein the refrigerant composition has a single liquid phase over the range of the composition and over a range of temperature from about −40° C. to about +200° C.

21.-24. (canceled)
